(19) United States
(12) Patent Application Publication
(10) Pub. No.: US 2025/0086330 A1
(43) Pub. Date: Mar. 13, 2025

(54) SYSTEM AND METHOD FOR GENERATING A TOPOLOGY OPTIMIZED CONFORMAL PANEL INFILL GEOMETRY OF A SANDWICH PANEL

(71) Applicant: The Boeing Company, Arlington, VA (US)

(72) Inventors: Michael C. Elford, Brisbane (AU); Yunpeng Zhang, Brisbane (AU)

(21) Appl. No.: 18/466,602

(22) Filed: Sep. 13, 2023

(51) Int. Cl. G06F 30/10

(52) U.S. Cl. CPC G06F 30/10; G06F 2113/10

(57) ABSTRACT

A method of generating a panel infill geometry of a sandwich panel is provided. The method includes providing a mid-surface computer-aided design (CAD) geometry and generating a first driver mesh of the mid-surface CAD geometry. The method further includes generating a density field using a topology optimization algorithm, and further includes computing a second driver mesh based on the density field. The second driver mesh includes quadrilateral elements that have element sizes computed based on the density field. The method further includes providing a reference unit cell mesh that includes a unit infill mesh and a pair of unit face sheet meshes, and further includes mapping copies of the reference unit cell mesh onto hexahedral elements associated with the quadrilateral elements to form a sandwich panel mesh interconnecting a pair of face sheet meshes. The method further includes outputting the sandwich panel mesh including the infill and face sheet meshes.

### FIELD

The present disclosure relates generally to additive manufacturing and relates specifically to the additive manufacturing of sandwich panels.

### BACKGROUND

Sandwich panels are panels in which a low-density infill is located between an upper skin and a lower skin (also referred to as upper and lower face sheets). Such a structure allows sandwich panels to have lower weights and higher performance-to-weight ratios than solid panels that have the same dimensions. Sandwich panels are, for example, frequently used in aircraft, buildings, and product packaging.

### SUMMARY

According to one aspect of the present disclosure, a method of generating a panel infill geometry of a sandwich panel is provided. The method includes providing a mid-surface computer-aided design (CAD) geometry representing a panel mid-surface of a sandwich panel. The mid-surface CAD geometry has a 2-manifold form. The method further includes generating a first driver mesh of the mid-surface CAD geometry. The first driver mesh includes a first plurality of quadrilateral elements. Using a topology optimization algorithm that has one or more objective functions, the method further includes generating a density field defined on the first driver mesh. The method further includes computing a second driver mesh of the mid-surface CAD geometry based at least in part on the density field. The second driver mesh includes a second plurality of quadrilateral elements. The second plurality of quadrilateral elements have respective element sizes specified by an element size field that is computed based at least in part on the density field. The method further includes providing a reference unit cell mesh that has a unit cell geometry configured to fit within a cube. The reference unit cell mesh includes a unit infill mesh and a pair of unit face sheet meshes at opposite ends of the unit infill mesh. The method further includes mapping a plurality of copies of the reference unit cell mesh onto a respective plurality of hexahedral elements associated with the second plurality of quadrilateral elements. The mapped copies of the reference unit cell mesh form a sandwich panel mesh that has a panel infill mesh interconnecting a pair of face sheet meshes. The method further includes outputting a sandwich panel mesh including the panel infill mesh and the face sheet meshes.

### BRIEF DESCRIPTION OF THE DRAWINGS

FIGS. 1A-1B show a flowchart of a method of generating a panel infill geometry of a sandwich panel, according to one example embodiment.

FIG. 2A shows an example conventional sandwich panel that includes a first face sheet, a second face sheet, and a panel infill structure.

FIG. 2B shows an example cross-sectional view of the panel infill structure of the sandwich panel of FIG. 2A.

FIG. 3A shows another example sandwich panel in which the first face sheet and the second face sheet are curved.

FIG. 3B shows a cross-sectional view of the sandwich panel of FIG. 3A.

FIG. 4 shows additional steps of the method of FIGS. 1A-1B that are performed in some examples.

FIG. 5A schematically shows an example mid-surface CAD geometry for a sandwich panel, according to the example of FIGS. 1A-1B. FIG. 5A also illustrates loads and boundary conditions applied to the sandwich panel.

FIG. 5B shows an example first driver mesh generated from the mid-surface CAD geometry of FIG. 5A.

FIG. 5C shows an example of a region of a density field above a threshold value generated by applying a topology optimization algorithm to the driver mesh of FIG. 5B using the loading and boundary conditions shown in FIG. 5A.

FIG. 5D shows a three-dimensional view of a part generated using a topology optimization algorithm according to a conventional approach, with material retained in the shaded regions of FIG. 5C.

FIG. 5E shows an example second driver mesh of the mid-surface CAD geometry that is computed using the density field of FIG. 5C.

FIG. 5F shows an example smoothed panel infill mesh generated from the second driver mesh of FIG. 5E.

FIG. 5G shows an example cutaway view of a sandwich panel including a panel infill structure additively manufactured as specified by the smoothed panel infill mesh of FIG. 5F.

FIG. 6A shows another example mid-surface CAD geometry for a sandwich panel, according to the example of FIGS. 1A-1B. FIG. 6A also illustrates loads and boundary conditions applied to the sandwich panel.

FIG. 6B shows an example of a region of a density field above a threshold value generated by applying a topology optimization algorithm to the first driver mesh of FIG. 5B using the loading and the boundary conditions shown in FIG. 6A.

FIG. 6C shows a three-dimensional view of a part generated using a topology optimization algorithm according to a conventional approach, with material retained in the shaded regions of FIG. 6B.

FIG. 6D shows an example second driver mesh that is computed using the density field of FIG. 6B.

FIG. 6E shows an example smoothed panel infill mesh generated from the second driver mesh of FIG. 6D.

FIG. 6F shows an example cutaway view of a sandwich panel manufactured using the smoothed panel infill mesh of FIG. 6E.

FIG. 7A schematically shows a non-planar example mid-surface CAD geometry that defines a sandwich panel that is curved and branched, according to the example of FIGS. 1A-1B. FIG. 7A also illustrates loads and boundary conditions applied to the sandwich panel.

FIG. 7B shows an example first driver mesh generated from the mid-surface CAD geometry of FIG. 7A.

FIG. 7C shows an example of a region of a density field above a threshold value generated by applying a topology optimization algorithm to the first driver mesh of FIG. 7B using the loads and boundary conditions shown in FIG. 7A.

FIG. 7D shows a three-dimensional view of a part generated using a topology optimization algorithm according to a conventional approach, with material retained in the shaded regions of FIG. 7C.

FIG. 7E shows an example second driver mesh generated from the density field of FIG. 7C.

FIG. 7F shows an example cutaway view of a smoothed panel infill mesh generated from the second driver mesh of FIG. 7E.

FIG. 7G shows an example cutaway view of a sandwich panel manufactured as specified by the smoothed panel infill mesh of FIG. 7F with skin removed along a portion of the part to allow visualization of the underlying smoothed panel infill mesh.

FIG. 8A schematically shows a computing device at which a processor is configured to generate a converged density field, according to the example of FIGS. 1A-1B.

FIG. 8B schematically shows the computing device when the processor is configured to further process an element size field, according to the example of FIGS. 1A-1B.

FIG. 8C schematically shows the computing device when the processor is further configured to generate a sandwich panel mesh using a second driver mesh, according to the example of FIGS. 1A-1B.

FIG. 9 schematically shows an example computing system in which the computing device is instantiated, according to the example of FIGS. 8A-8C.

### DETAILED DESCRIPTION

Sandwich panels are a type of structure which consists of two face sheets (also referred to as skins) with a light weight infill (core) structure in-between. Sandwich panels are structurally efficient for bending loads because the light weight infill creates a significant distance between the two face sheets which greatly increases the stiffness and strength of the panel in bending when compared to the face sheet alone. The light weight infill acts to prevent buckling of the face sheets and also to react out-of-plane shear loading. A common shape of infill is the honeycomb pattern which consists of a hexagon tessellation (e.g. regular tiling) of a Euclidean plane.

Honeycomb sandwich panels are common in packaging, where both the face sheets and the honeycomb infill are made from cardboard. Honeycomb sandwich panels are also common in the design of aerospace structures where the face sheets are and infill are made from metal alloys or composite material. The face sheets are typically bonded (e.g. glued) on to the infill structure. In both instances, the mass of the panel is designed to be as low as possible whilst still allowing the panel to perform the tasks it was designed to do. However, the density of the infill in such panels is uniform and this typically prevents the panel from achieving the minimum mass for a given combination of loading and boundary conditions that it was designed to withstand. Therefore, a need exists for a method of generating and manufacturing sandwich panels which have a higher density infill to support heavily loaded areas of a sandwich panel and sparser infill in regions of light loading, resulting in a sandwich panel with a higher performance to weight ratio.

Additive manufacturing, sometimes referred to as 3D printing, is a manufacturing approach in which a component is constructed by iteratively depositing a material on a surface of some component or substrate, such as a printer bed. In contrast to other manufacturing techniques, such as molding or subtractive manufacturing, additive manufacturing allows a wider variety of geometries to be produced.

Since additive manufacturing enables the use of geometries that would be impractical to achieve with other manufacturing techniques, additively manufactured sandwich panels can be manufactured as one monolithic part with an infill geometry having a variation of shape and size which advantageously increases the performance to weight ratio of the panel.

Devices and methods for the geometry generation and subsequent additively manufacturing a sandwich panel are provided below. Using these devices and methods, a sandwich panel is additively manufactured in a manner that allows the performance-to-weight ratio of the panel to be increased in comparison to those made with traditional sandwich panel manufacturing and assembly techniques. In addition, the manufacturing method discussed below generates an infill suitable for a given combination of loading and boundary conditions.

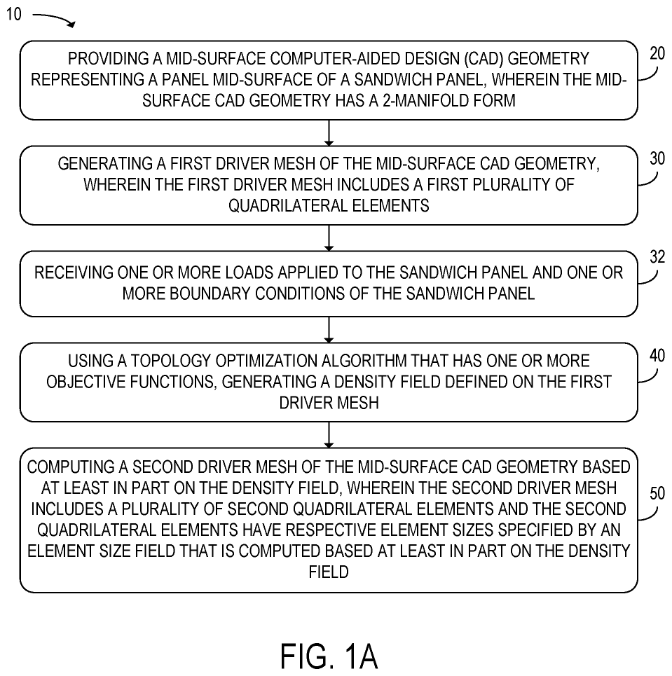

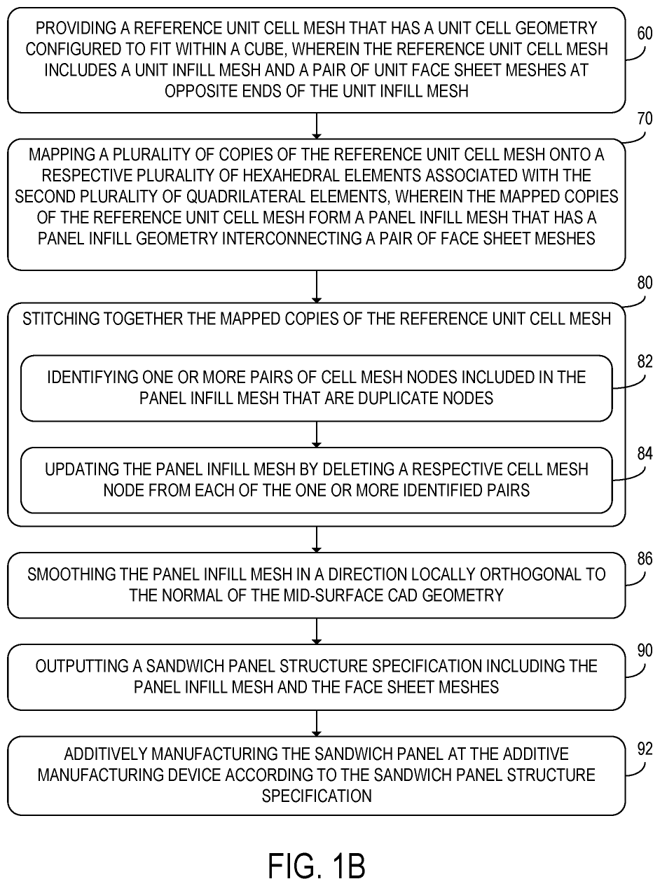

FIGS. 1A-1B show a flowchart of a method 10 of generating a panel infill geometry of a sandwich panel, according to one example embodiment. The steps of the method 10 of FIG. 1 are performed at a computing device that is configured to transmit instructions to an additive manufacturing device.

At step 20, the method 10 includes providing a mid-surface computer-aided design (CAD) geometry representing a panel mid-surface of a sandwich panel. The mid-surface CAD geometry has a 2-manifold form (i.e. an infinitely thin surface). The panel mid-surface represented by the mid-surface CAD geometry is a surface located midway between the face sheets of the sandwich panel. In some examples, 2-manifolds representing the face sheets of the sandwich panel are also provided along with the mid-surface CAD geometry.

At step 30, the method 10 further includes generating a first driver mesh of the mid-surface CAD geometry. The first driver mesh includes a first plurality of quadrilateral elements. In some examples, the first plurality of quadrilateral elements are four-noded quadrilateral elements. In other examples, the first plurality of quadrilateral elements are eight-noded quadrilateral elements, or quadrilateral elements with some other number of nodes.

At step 32, the method 10 further includes receiving one or more loads applied to the sandwich panel and one or more boundary conditions applied to the sandwich panel. The type of loads and boundary conditions which can be applied are defined by the type of physical system that is used in conjunction with a topology optimization algorithm, as discussed below. In some examples, the physical system is structural, and the one or more loads may include one or more traction forces acting on portions of the domain boundary. In such examples, the one or more boundary conditions may include zero-displacement portions of the domain boundary. In other examples, the physical system is thermal, and the one or more loads may include one or more heat fluxes acting on portions of the domain boundary. The one or more boundary conditions in such examples may include fixed temperatures on other portions of the domain boundary. In other examples, the physical system is electrical, and the one or more loads may include electric field source terms acting on portions of the domain boundary. The one or more boundary conditions in such examples may include a perfectly electrically conducting (PEC) condition assigned to other portions of the domain boundary. Other loads and boundary conditions are applied to the physical system in other examples.

At step 40, the method 10 further includes generating a density field defined on the first driver mesh using a topology optimization algorithm. The topology optimization algorithm, which is coupled to a physics solver, solves a topology optimization problem on the design domain, as specified by the one or more loads and the one or more boundary conditions and the first driver mesh. The design domain is typically the first driver mesh however, in some examples, the design domain may be a subset of elements in the first driver mesh. The value of the density field at a location represents the fraction of material that is placed at that location within the design domain. The topology optimization algorithm has one or more objective functions, also referred to as goal functions, that specify one or more respective quantities that the density field is generated to approximately maximize or minimize. For example, the one or more objective functions can include an elastic strain energy objective function, a thermal energy objective function, an electrical energy objective function, and/or an acoustic energy objective function, as discussed in further detail below.

Performing the topology optimization algorithm includes performing multiple subsequent iterations of a physics solver over the design domain. The physics solver is a numerical algorithm which solves a set of governing partial differential equations that describe the physical system to be optimized. Examples of such algorithms include, but are not limited to, a Galerkin method (e.g., the finite element method or isogeometric analysis), a finite volume method, a discontinuous Galerkin method, a stochastic method (e.g., random walk or walk on spheres), a finite difference method, and a spectral method. Other numerical algorithms can be employed to solve the governing equations in other examples.

In some examples, the topology optimization algorithm is a Solid Isotropic Material with Penalization (SIMP) algorithm, a Rational Approximation of Material Properties (RAMP) algorithm, an Evolutionary Structural Optimization (ESO) algorithm, a Bi-Directional Evolutionary Structural Optimization (BESO) algorithm, a Level Set Topology Optimization (LSTO) algorithm, or a Phase Field Topology Optimization (PFTO) algorithm. Other topology optimization algorithms can be used to generate the density field in other examples.

At step 50, the method 10 further includes computing a second driver mesh of the mid-surface CAD geometry based at least in part on the density field computed with the topology optimization algorithm. The second driver mesh includes a second plurality of quadrilateral elements. Similarly to the first plurality of quadrilateral elements, the second plurality of quadrilateral elements can be four-noded quadrilateral elements, eight-noded quadrilateral elements, or quadrilateral elements specified using some other number of nodes. The second plurality of quadrilateral elements are isoparametric elements in some examples. When the second driver mesh is generated at step 50, the second plurality of quadrilateral elements are computed to have respective element sizes specified by an element size field. The element size field is computed based at least in part on the density field, as discussed in further detail below.

FIG. 1B shows further steps of the method 10 performed subsequently to step 50. At step 60, the method 10 further includes providing a reference unit cell mesh that has a unit cell geometry configured to fit within a cube. The reference unit cell mesh includes a unit infill mesh. The reference unit cell mesh further includes a pair of unit face sheet meshes, which are located at opposite ends of the unit infill mesh. The reference unit cell mesh defines a unit shape with which the panel infill geometry is composed.

At step 70, the method 10 further includes mapping a plurality of copies of the reference unit cell mesh onto a respective plurality of hexahedral elements associated with the second plurality of quadrilateral elements. In some examples, these hexahedral elements are defined by an extrusion of each of the elements in the second plurality of quadrilateral elements. In at least one example, each of the second plurality of quadrilateral elements are extruded in directions locally normal to the mid-surface, for distances equal to half the thickness of the sandwich panel on either side in order to generate a plurality of hexahedral elements. The mapped copies of the reference unit cell meshes form a sandwich panel mesh that has a panel infill geometry interconnecting a pair of face sheet meshes. Accordingly, the sandwich panel geometry is generated using the copies of the reference unit cell mesh as units from which the sandwich panel mesh is constructed.

The process of mapping the unit cells at step 70 causes adjustment in the sizes and shapes of the copies of the reference unit cell mesh. In at least one embodiment, the mapping in step 70 is performed using basis functions. Basis functions describe the value of a point of interest within a region, using a weighted combination of values at points around the point of interest. The following linear basis functions are used in some examples where the second plurality of quadrilateral elements are four-noded quadrilateral elements:

$${N}_{1} = \frac{1}{4} ( 1 - ξ ) ( 1 - η ) \\ {N}_{2} = \frac{1}{4} ( 1 + ξ ) ( 1 - η ) \\ {N}_{3} = \frac{1}{4} ( 1 + ξ ) ( 1 + η ) \\ {N}_{4} = \frac{1}{4} ( 1 - ξ ) ( 1 + η )$$

In the above equations, ξ and η are coordinates of the reference unit cell mesh node in isoparametric space and the subscripts 1-4 represent the node number that the basis function refers to.

The outputs of the basis functions N₁, N₂, N₃, and N₄ are used to compute a respective normal vector n=(nₓ, n_{y}, n_{z})^{T} of the mid-surface CAD geometry at each of the second plurality of quadrilateral elements. The following equations are used in some examples to compute the components of the normal vector:

$${n}_{x} = {\sum }_{i = 1}^{4} {N}_{i} {n}_{{i}_{x}} \\ {n}_{y} = {\sum }_{i = 1}^{4} {N}_{i} {n}_{{i}_{y}} \\ {n}_{z} = {\sum }_{i = 1}^{4} {N}_{i} {n}_{{i}_{z}}$$

In the above equations, nᵢ_{ₓ}, nᵢ_{_{y}}, and nᵢ_{_{z}} are averages of element normal vectors, computed at nodes belonging to the second plurality of quadrilateral elements, that have normal vectors n₁ . . . n₄ corresponding to nodes 1-4 in each element.

Subsequently to computing the normal vector n, the respective position vector p=(pₓ, p_{y}, p_{z}) of each reference unit cell mesh node is computed. The following equations can be used to compute the components of the position vector:

$${p}_{x} = {\sum }_{i = 1}^{4} {N}_{i} {p}_{{i}_{x}} + \frac{1}{2} ζ {n}_{x} t \\ {p}_{y} = {\sum }_{i = 1}^{4} {N}_{i} {p}_{{i}_{y}} + \frac{1}{2} ζ {n}_{y} t \\ {p}_{z} = {\sum }_{i = 1}^{4} {N}_{i} {p}_{{i}_{z}} + \frac{1}{2} ζ {n}_{z} t$$

In the above equations, ζ is a third isoparametric coordinate, and pᵢ_{ₓ}, pᵢ_{_{y}}, and pᵢ_{_{z}} are the x, y, and z coordinates of the position vectors p₁ . . . p₄ of the nodes of an element belonging to the second plurality of quadrilateral elements. Accordingly, the coordinates of the copies of the reference unit cell mesh are mapped to the plurality of hexahedral elements respectively associated with the second plurality of quadrilateral elements.

Although the above example illustrates the use of linear basis functions, alternative embodiments may utilize quadratic, cubic, quartic or in general n^{th} order polynomial basis functions. In some embodiments these basis functions are the dyadic (tensor) product of one dimensional Lagrange polynomials.

At step 80, the method 10 further includes stitching together the mapped copies of the reference unit cell mesh. In the example of FIG. 1B, step 80 includes, at step 82, identifying one or more pairs of cell mesh nodes included in the sandwich panel mesh that are duplicate nodes. These duplicate nodes have shared locations within the panel infill mesh. At step 84, step 80 further includes updating the sandwich panel mesh by deleting a respective cell mesh node from each of the one or more identified pairs and updating the node numbering on elements which contain the deleted node number to instead refer to the retained node number. Redundant nodes are accordingly deleted from the sandwich panel mesh.

Following step 80, the method 10 further includes step 86 in some examples. At step 86, the method 10 further includes smoothing the mesh in a direction locally orthogonal to the normal of the mid-surface of the sandwich panel.

At step 90, the method 10 further includes outputting a sandwich panel mesh including the panel infill mesh and the face sheet meshes. The sandwich panel mesh is output to an additive manufacturing device in the example of FIG. 1B. Accordingly, at step 92, the method 10 further includes additively manufacturing the sandwich panel geometry using the additive manufacturing device. In some examples, the sandwich panel is manufactured from metal, ceramic, or a combination thereof. In such examples, the sandwich panel can be manufactured via laser powder bed fusion, selective laser melting, electron beam powder bed fusion, directed energy deposition, wire arc additive manufacturing, wire-feed electron beam additive manufacturing, binding jetting, supersonic particle deposition, and/or friction stir additive manufacturing. In other examples, the sandwich panel is manufactured from polymer. The sandwich panel can be manufactured using digital light processing, selective laser sintering, fused deposition modelling, material jetting, and/or stereolithography. Other materials and/or additive manufacturing methods are used to manufacture the sandwich panel in other examples.

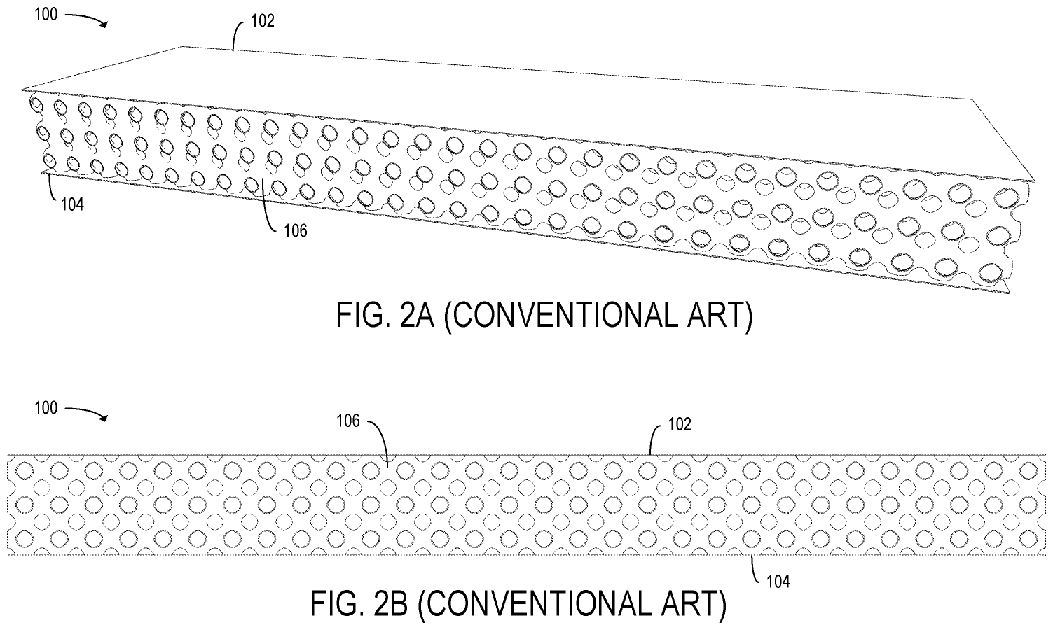

FIG. 2A shows an example sandwich panel 100 that includes a first face sheet 102 and a second face sheet 104. The sandwich panel 100 further includes a panel infill structure 106 located between the first face sheet 102 and the second face sheet 104. FIG. 2B shows an example cross-sectional view of the panel infill structure 106, first face sheet 102 and second face sheet 104, of the sandwich panel 100. In the example of FIGS. 2A-2B, the sandwich panel 100 is a flat sandwich panel.

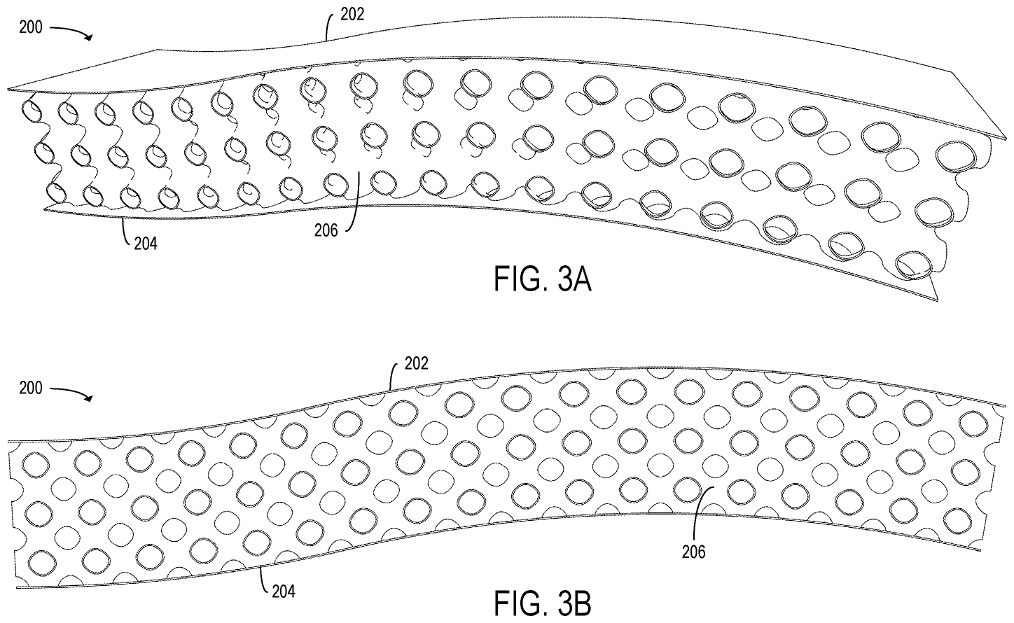

FIG. 3A shows another example sandwich panel 200. In contrast to the flat sandwich panel 100 of FIGS. 2A-2B, the first face sheet 202 and the second face sheet 204 of the sandwich panel 200 of FIG. 3A are curved. Due to the non-planar shape of the first face sheet 202 and the second face sheet 204, the panel infill structure 206 of the sandwich panel 200 has repeating unit cells that vary in size and shape at different locations within the sandwich panel 200 but which maintain a consistent topology at the interface between the face sheets 202, 204 and the panel infill structure 206. Furthermore, all repeating unit cells conform to the shape of the mid-surface of sandwich panel 200. FIG. 3B shows a cut-away view of the sandwich panel 200 in which these differences in size and shape as well as the conformal nature of the repeating cells is visible.

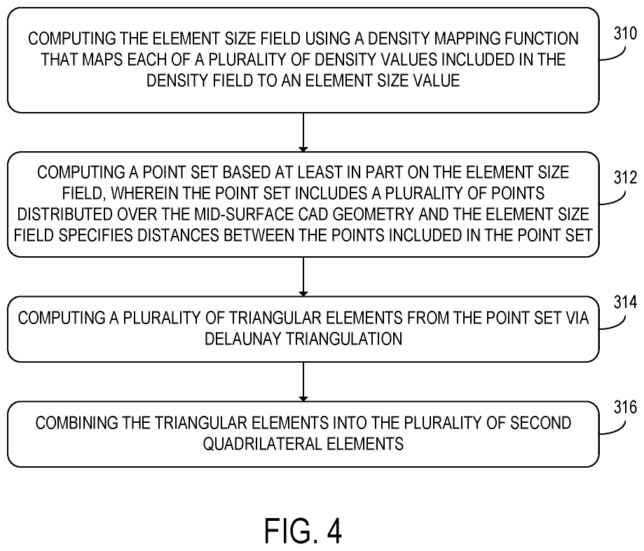

In the example of FIG. 4, the method 10 further includes steps that are performed in some examples when computing the second driver mesh at step 50. At step 310, in some examples, the method 10 further includes computing the element size field using a density mapping function. The density mapping function takes in a density value as input and, for each of a plurality of density values included in the density field generated by the topology optimization algorithm, outputs a corresponding target element size. In one embodiment, the target element size may be only one of two possible values: a maximum target element size, when a density value is below a threshold density value, or a minimum target element size, when a density value is above a threshold density value. In other examples, there may be multiple values for target element sizes. In one such embodiment the cell size varies linearly between two target element sizes. In another embodiment, the target element size varies non-linearly with respect to the density value. At step 312, the method 10 further includes computing a point set based at least in part on the element size field. The point set includes a plurality of points distributed over the mid-surface CAD geometry, and the element size field specifies distances between the points included in the point set.

At step 314, the method 10 further includes computing a plurality of triangular elements from the point set via Delaunay triangulation. The points included in the point set are located at the vertices of the triangular elements. At step 316, the method 10 further includes combining the triangular elements into a second plurality of quadrilateral elements. Each of the elements in the second plurality of quadrilateral elements is computed by combining a pair of the triangular elements. Thus, the second driver mesh is generated in a manner in which the sizes of the quadrilateral elements depend upon the density values included in the density field generated by the topology optimization algorithm. In other embodiments, a second plurality of quadrilateral elements may be generated directly without the intermediary step of generating triangular elements. For example, in at least one embodiment, a paver meshing class of algorithm directly produces a plurality of quadrilateral elements from the point set.

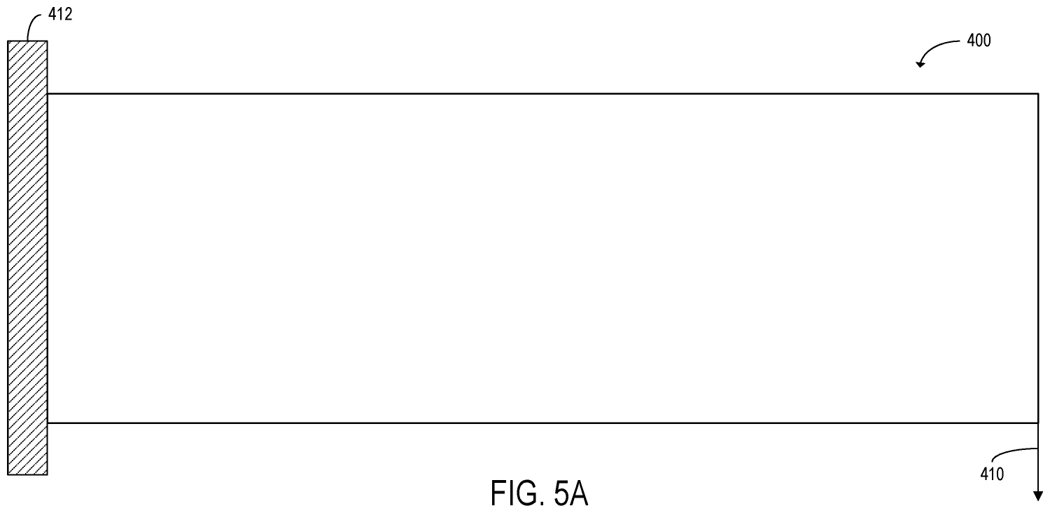

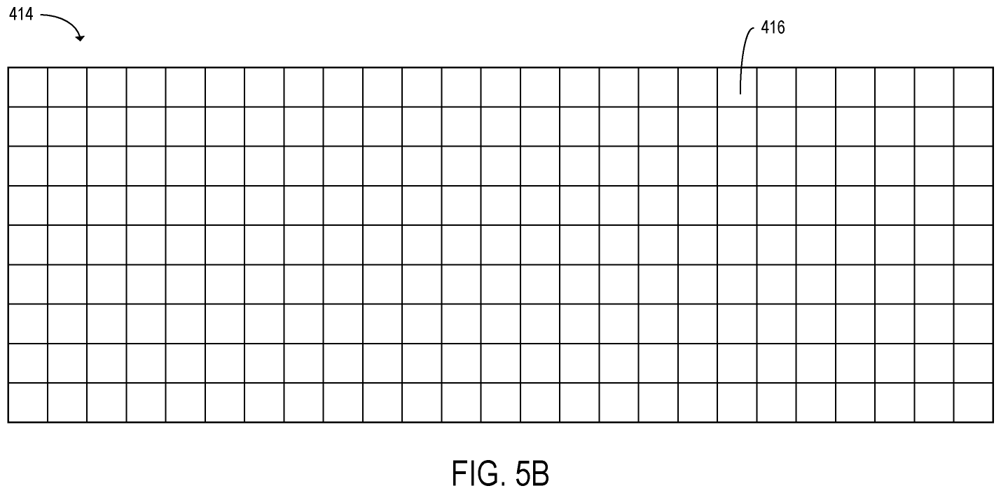

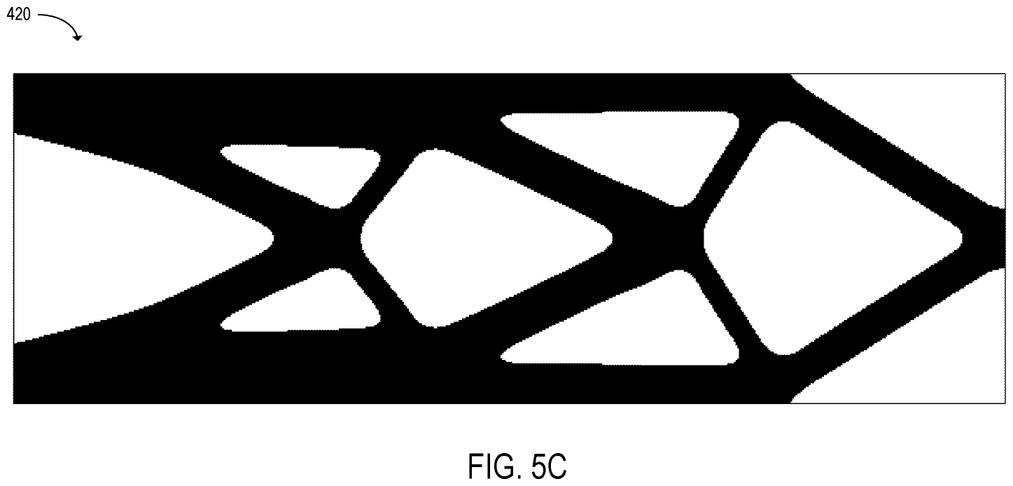

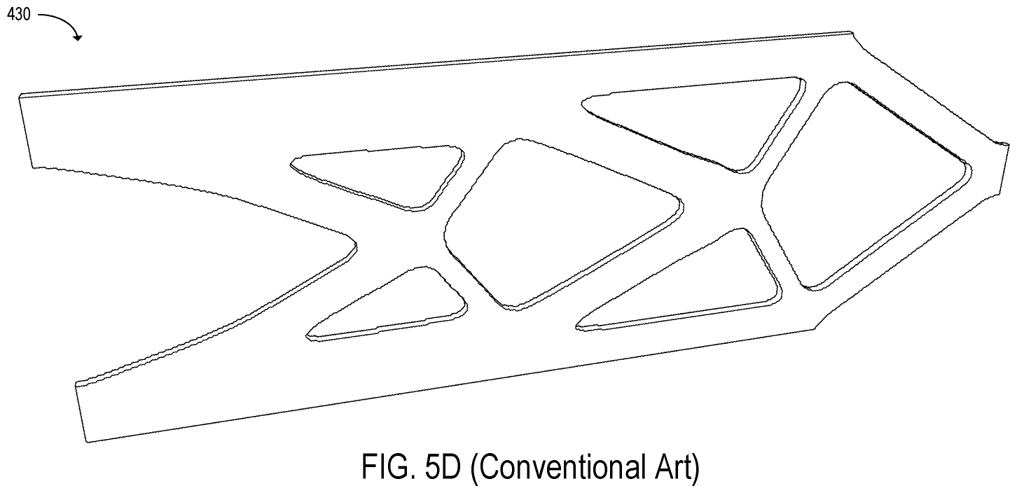

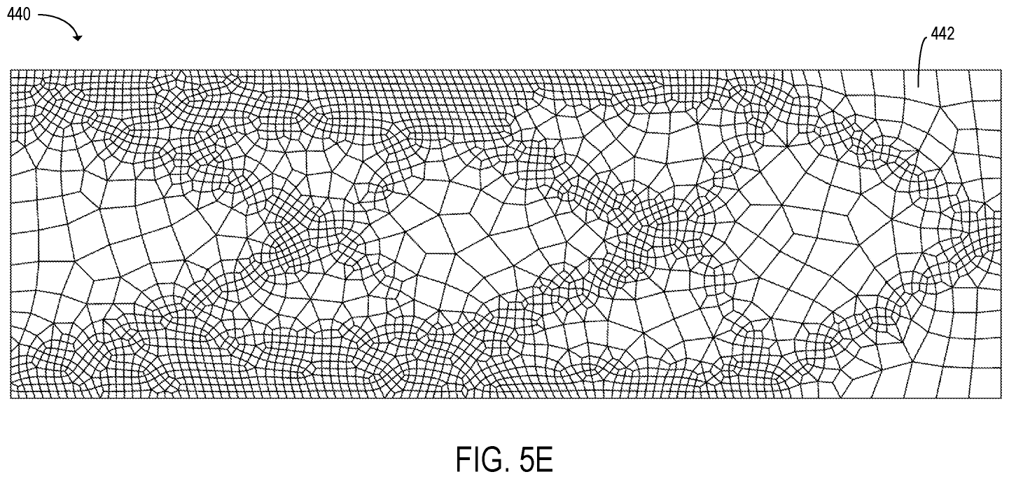

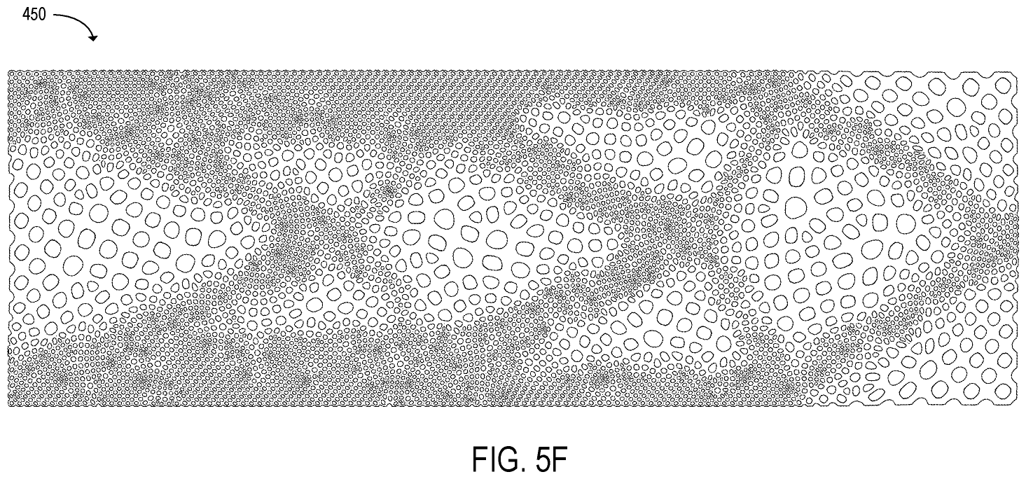

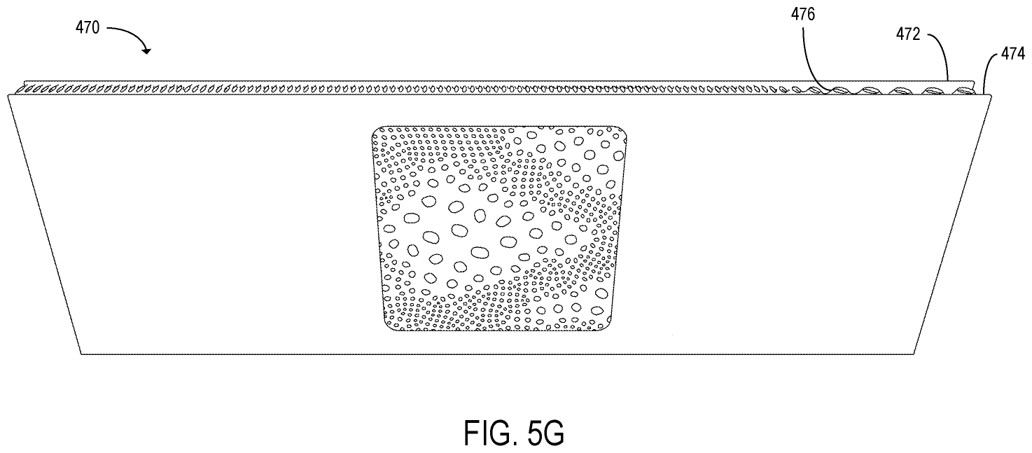

FIG. 5A schematically shows an example mid-surface CAD geometry 400 for a sandwich panel 100, according to one example. In the example of FIG. 5A, the mid-surface CAD geometry 400 is a flat, rectangular geometry. A mechanical force 410 is also applied as a load to the sandwich panel 100 in the example of FIG. 5A. In addition, a boundary condition 412 specifies a fixed location of the lefthand edge of the sandwich panel 100.

FIG. 5B shows an example first driver mesh 414 generated from the mid-surface CAD geometry 400 of FIG. 5A. The example first driver mesh 414 includes a first plurality of quadrilateral elements 416, which are square in the example of FIG. 5B.

FIG. 5C shows an example density field 420 generated by the topology optimization algorithm using the design domain of FIG. 5A, including the mechanical force 410 and boundary condition 412. The density values included in the density field 420 are specified with reference to the first plurality of quadrilateral elements 416 included in the first driver mesh 414. The density field 420 is illustrated here with only two colors: black to indicate density values above a threshold density value and white to indicate density values below a threshold value. Conventionally, this field is interpreted as each point on the design domain either retaining material (shown in black in the example of FIG. 5C) or having had material removed (shown in white in the example of FIG. 5C).

FIG. 5D shows a solid plate 430 generated using the example density field 420 according to conventional techniques. The solid plate 430 has a constant thickness. FIG. 5D shows how a density field generated with a topology optimization algorithm is typically used to generate a manufacturable structure which is tailored to specific loads and boundary conditions.

FIG. 5E shows an example second driver mesh 440 of the mid-surface CAD geometry 400 that is computed using a target element size field. The target element size field is generated by mapping each of the plurality of density field values belonging to density field 420 to target element size values using a density mapping function. The second driver mesh 440 includes a plurality of quadrilateral elements 442 with sizes governed by target element size values indicated in the target element size field. In some examples, the density mapping function receives density values included in the range [0,1]. In one example, the density mapping function outputs one of two possible target element sizes: a first target element size if the density at a given location is below a user-defined density threshold value, and a second element size if the density at that location is above the user-defined density threshold value. The first target element size is larger than the second target element size in this example. Accordingly, regions of the mid-surface CAD geometry 400 shown in black in FIG. 5C have the smaller of two possible target element sizes, whereas regions shown in white in FIG. 5C will have the larger of two possible target element sizes.

The quadrilateral elements 442 of the driver mesh 440 are generated such that their sizes approximate the target element size at their respective locations on the mid-surface CAD geometry 400. In order to provide a smooth transition of cell sizes, some of the quadrilateral elements 442 shown in FIG. 5E have sizes that are not equal to the first target element size or the second target element size.

FIG. 5F shows an example smoothed panel infill mesh 450 generated from the second driver mesh 440. The smoothed panel infill mesh 450 is shown in a two-dimensional top view in the example of FIG. 5F.

FIG. 5G shows an example cutaway view of a sandwich panel 470 including a panel infill structure 476 additively manufactured using the smoothed panel infill mesh 450 of FIG. 5F. The sandwich panel 470 further includes a first face sheet 472 and a second face sheet 474 located on opposite sides of the panel infill structure 476. As shown in the example cutaway view of FIG. 5G, the infill structure 476 is smoothed in directions that are locally orthogonal to the normal of the mid-surface 400 of sandwich panel 470 at every point on the surface (i.e. in directions locally tangent to the panel mid-surface at every point).

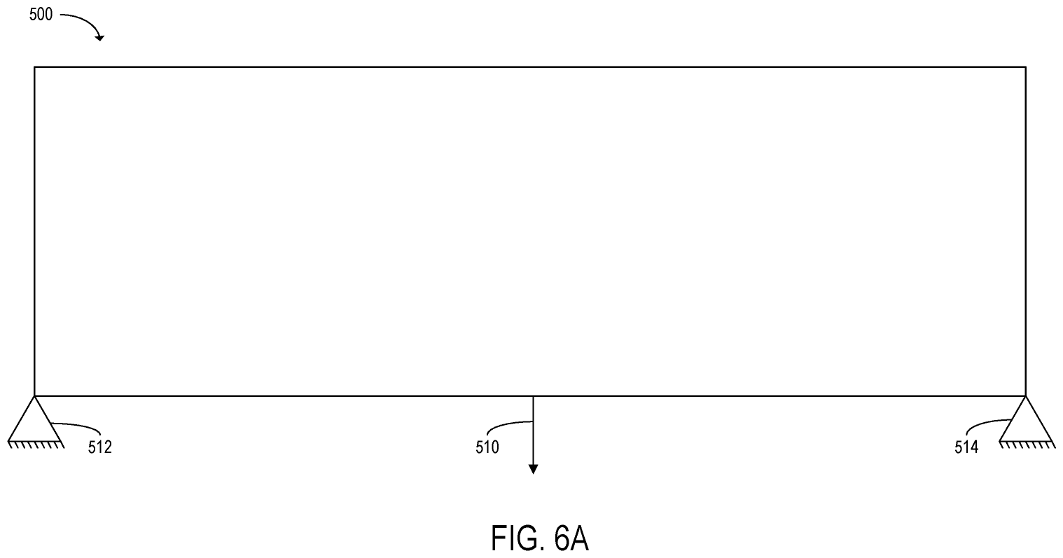

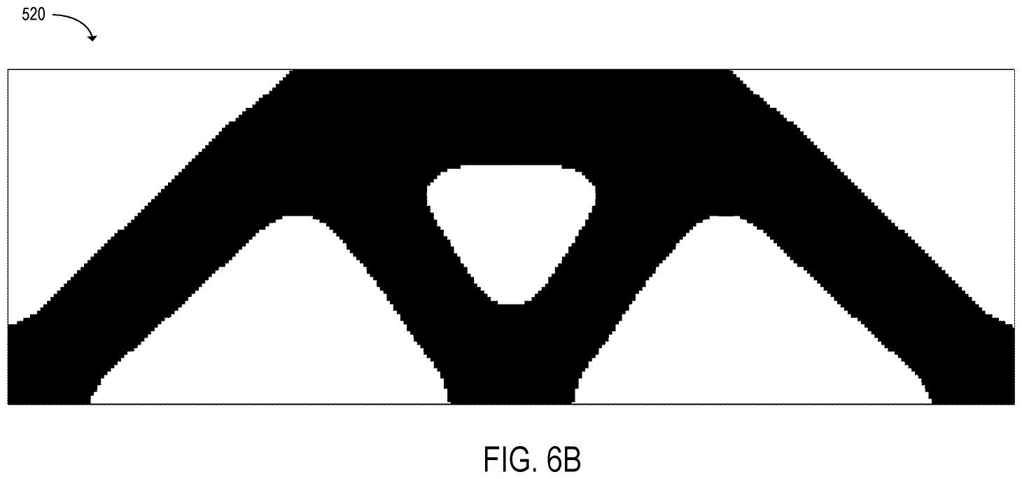

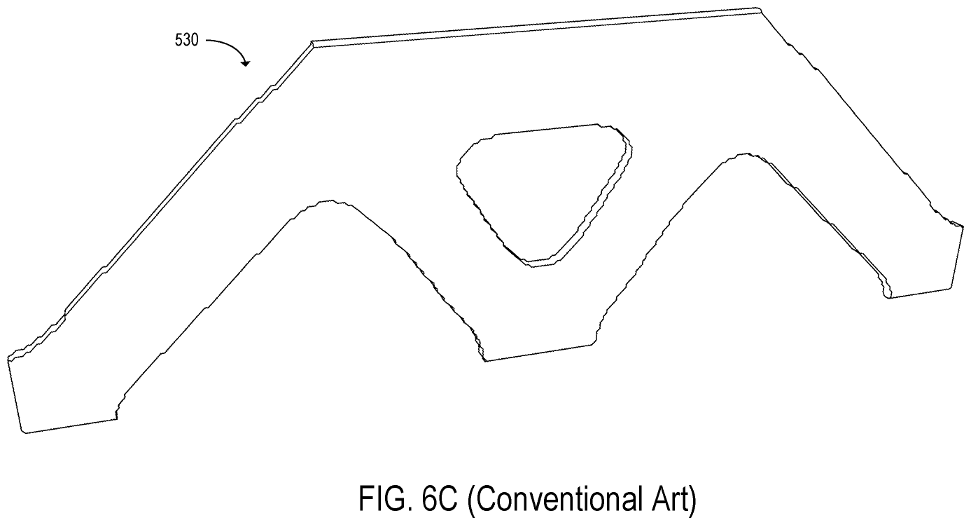

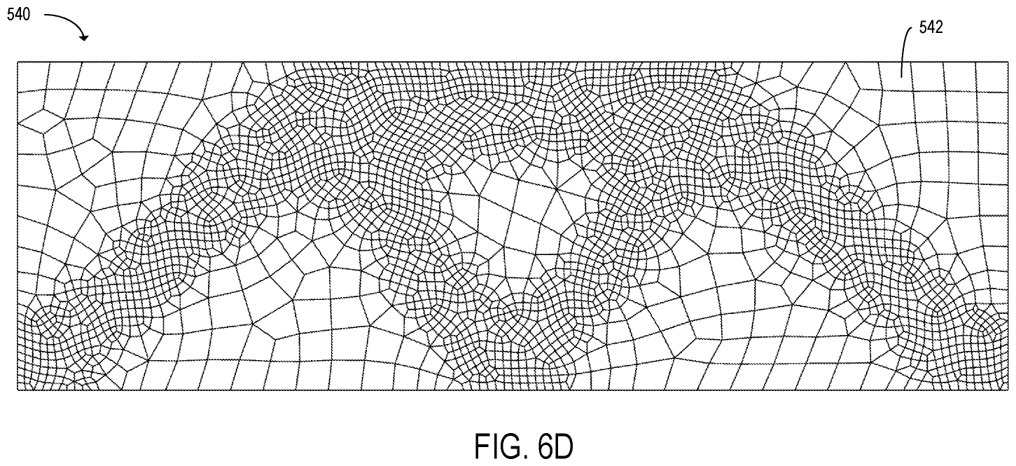

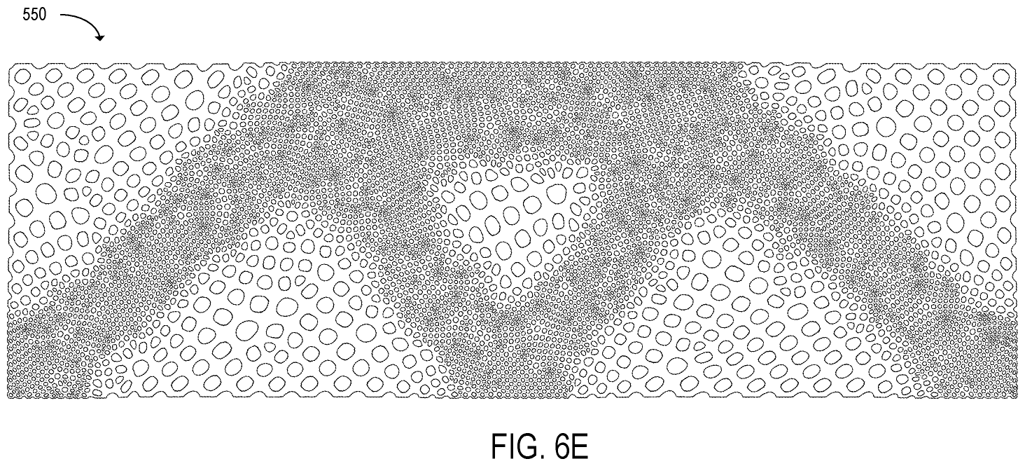

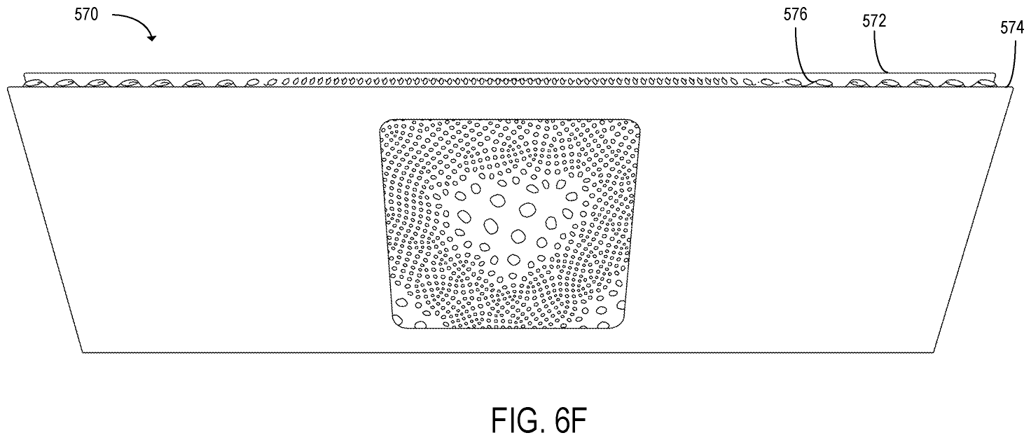

FIG. 6A shows another example mid-surface CAD geometry 500. In the example of FIG. 6A, a mechanical force 510 is applied to the center of the bottom edge of the sandwich panel as a load. The mid-surface CAD geometry 500 also includes a first boundary condition 512 and a second boundary condition 514 that respectively indicate that the locations of the lower lefthand corner and the lower righthand corner of the sandwich panel are fixed in position but are free to rotate around that point.

FIG. 6B shows an example density field 520 generated by the topology optimization algorithm using the first driver mesh 414 of FIG. 5B, including the mechanical force 510 and boundary conditions 512 and 514 as shown in FIG. 6A. The density values included in the density field 520 are specified with reference to the first plurality of quadrilateral elements 416 included in the first driver mesh 414. The density field 520 is illustrated here with only two colors: black to indicate density values above a threshold density value and white to indicate density values below a threshold value. FIG. 6C shows a solid plate 530 which represents the conventional interpretation of a density field generated by a topology analysis.

FIG. 6D shows an example second driver mesh 540 including a second plurality of quadrilateral elements 542. As in the example of FIG. 5E, the sizes of the second plurality of quadrilateral elements 542 are computed from the density values included in the density field 520 by mapping density values within the range [0,1] to either a first target element size or a second target element size.

FIG. 6E shows an example smoothed panel infill mesh 550 generated from the second driver mesh 540. FIG. 6F shows an example cutaway view of a sandwich panel 570 manufactured using the smoothed panel infill mesh 550. The sandwich panel 570 includes a first face sheet 572, a second face sheet 574, and a panel infill structure 576. The panel infill structure 576 is smoothed in directions that are locally orthogonal to the normal of the mid-surface of sandwich panel 570 at every point on the surface (i.e. in directions locally tangent to the panel mid-surface 400 at every point).

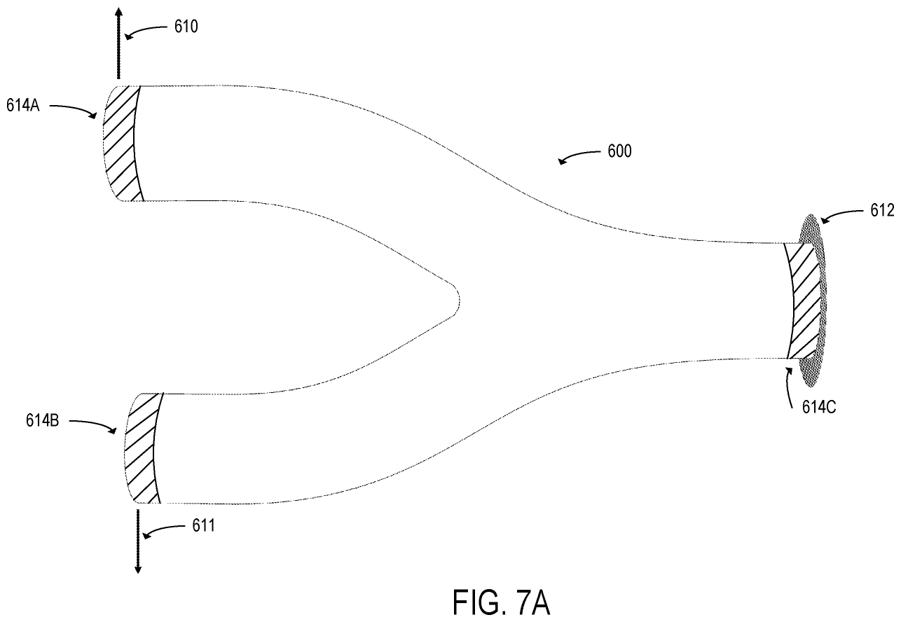

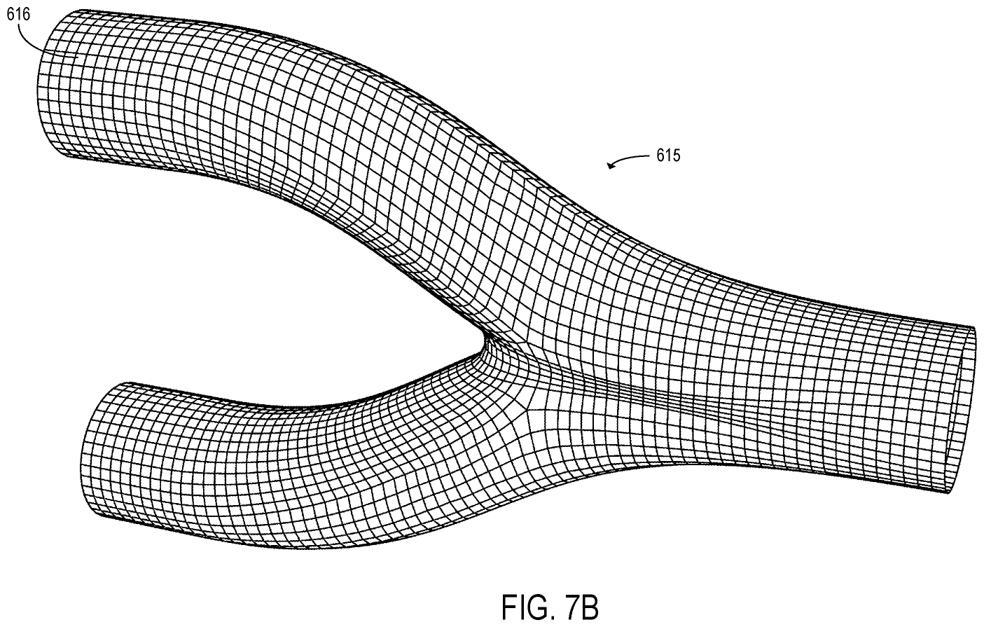

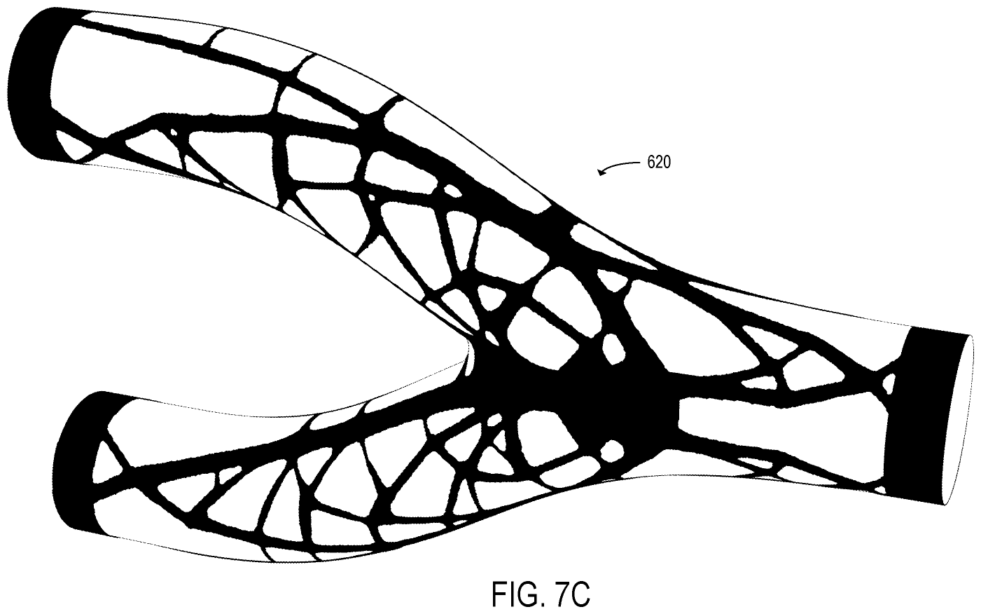

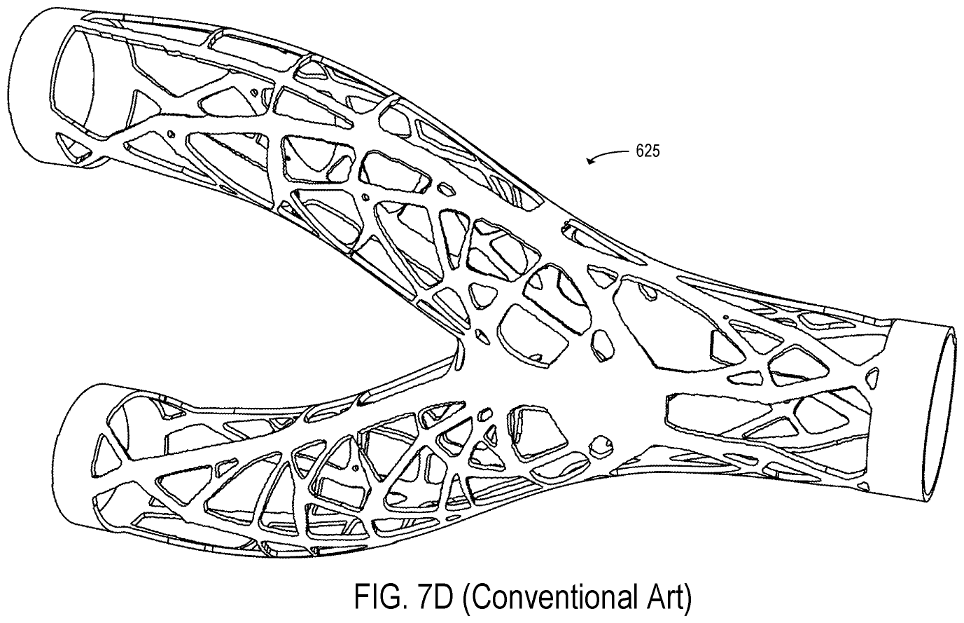

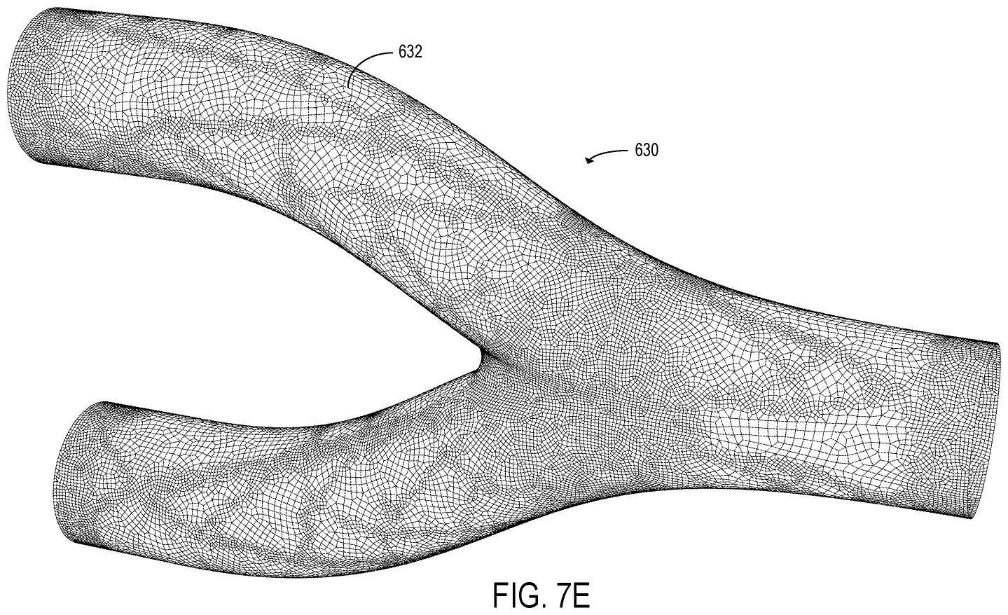

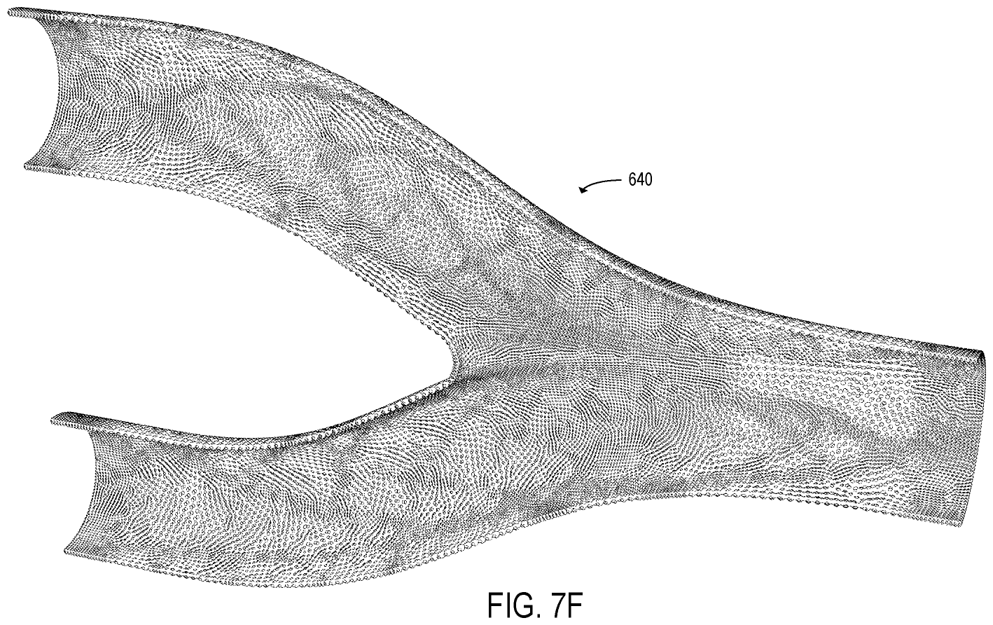

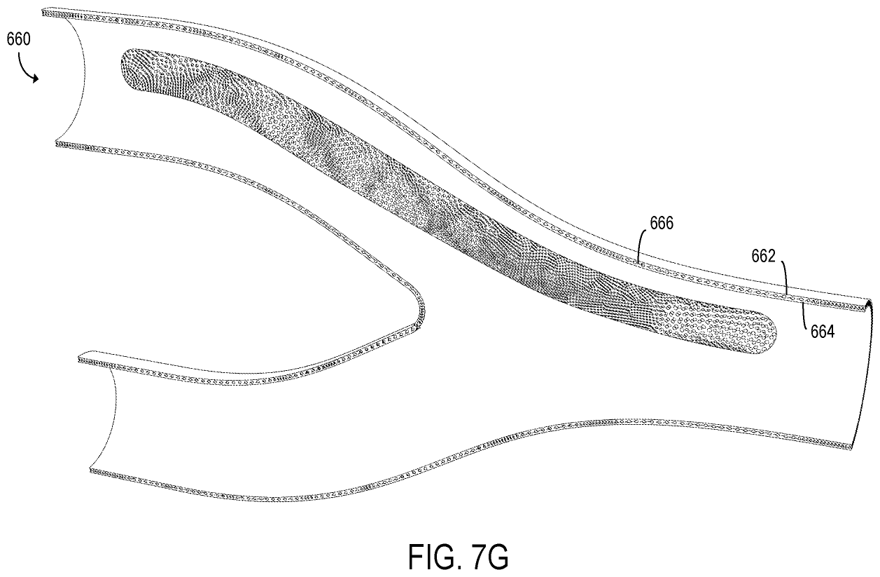

FIG. 7A schematically shows an example mid-surface CAD geometry 600 for a sandwich panel 200, according to one example. In the example of FIG. 7A, the mid-surface CAD geometry defines a curved, branched geometry rather than a planar geometry as given in the previous two examples. Mechanical forces 610 and 611 are applied as loads which act to pull the two branches apart. In addition, a boundary condition 612 specifies that all nodes residing the righthand circular edge of the mid-surface must remain fixed in position and no rotation can occur at these nodes. In FIG. 7A, region 614A, 614B and 614C indicate portions of the mid-surface CAD geometry 600 which have been constrained to have a density of one (e.g. material retained).

FIG. 7B shows an example first driver mesh 615 computed from the mid-surface CAD geometry shown in FIG. 7A. The first driver mesh 615 includes a first plurality of quadrilateral elements 616. Unlike in the example first driver mesh 414 of FIG. 5B, the first driver mesh 615 of FIG. 7A includes first plurality of quadrilateral elements 616 that have non-rectangular shapes.

FIG. 7C shows an example density field 620 generated by the topology optimization algorithm using first driver mesh 615, mechanical forces 610 and 611, boundary condition 612 and constraint conditions 614A, 614B and 614C of FIG. 7A. The density values included in the density field 620 are specified with reference to the first plurality of quadrilateral elements 616 included in the first driver mesh 615. The density field 620 is illustrated here with only two colors: black to indicate density values above a threshold density value and white to indicate density values below a threshold value. FIG. 7D shows a part 625 which represents the conventional interpretation of a density field generated by a topology analysis.

FIG. 7E shows an example second driver mesh 630 generated from the density field 620. The second driver mesh 630 includes a second plurality of quadrilateral elements 632. As in the examples of FIGS. 5E and 6D, a density mapping function maps each of a plurality of density values included in the density field 620 generated by the topology optimization algorithm to either a first target element size, when a density value is below a threshold density value, or a second target element size, when a density value is above a threshold density value.

FIG. 7F shows an example cutaway view of a smoothed panel infill mesh 640 generated from the second driver mesh 630. FIG. 7G shows an example cutaway view of a sandwich panel 660 including smoothed panel infill mesh 640 of FIG. 7F. The sandwich panel 660 includes a first face sheet 662, a second face sheet 664, and a panel infill structure 666. The panel infill structure 666 is smoothed in directions that are locally orthogonal to the normal of the mid-surface of sandwich panel at every point on the surface (i.e. in directions locally tangent to the panel mid-surface at every point).

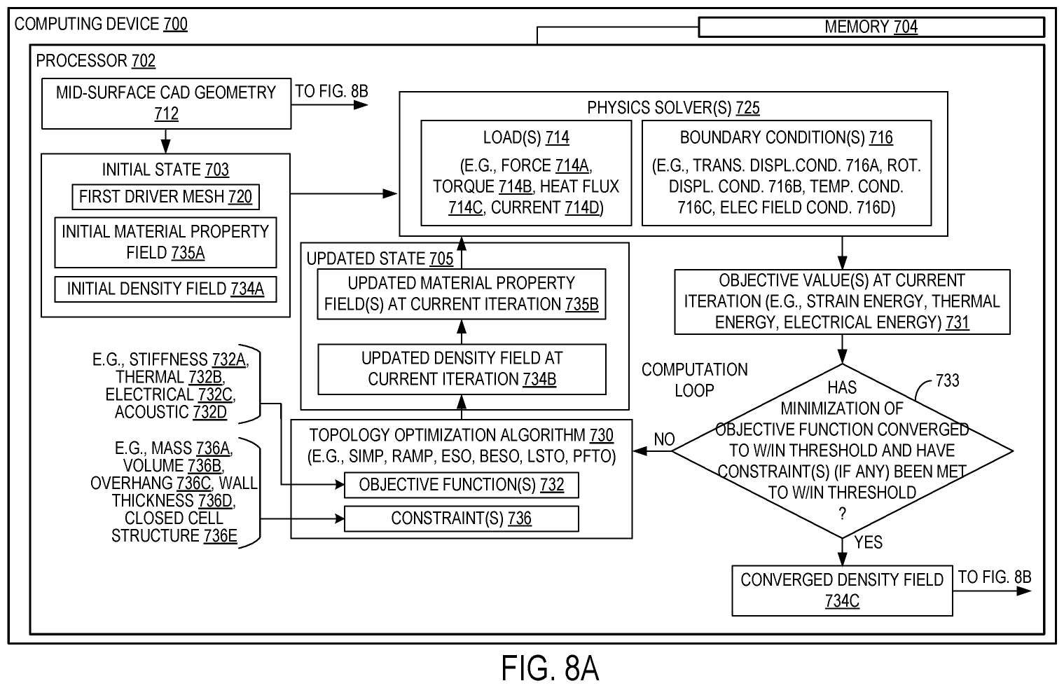

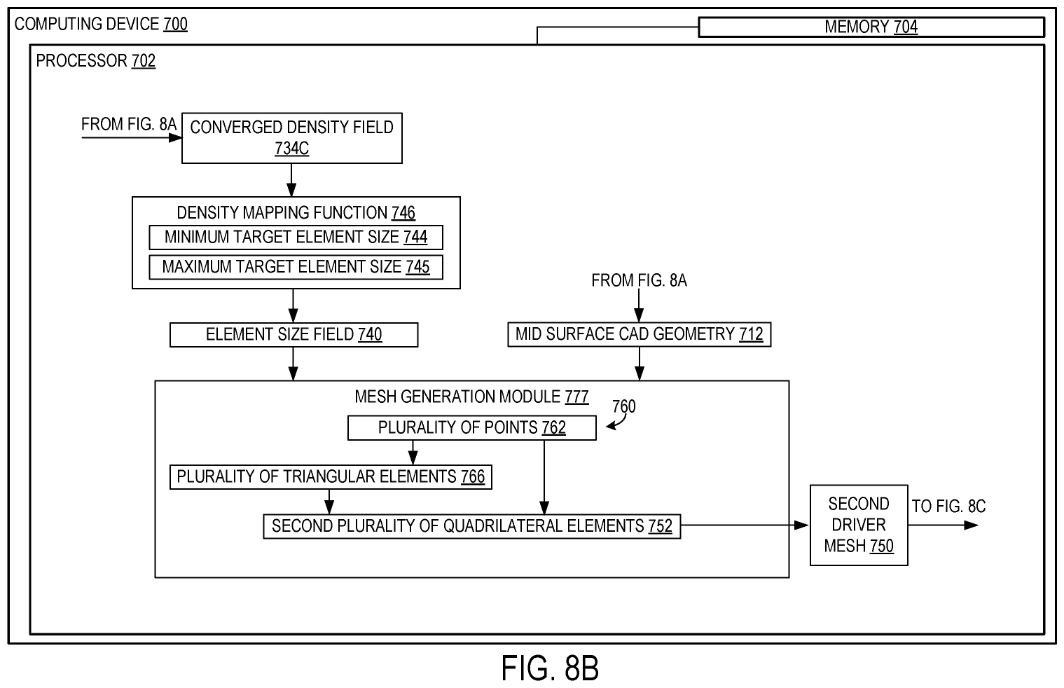

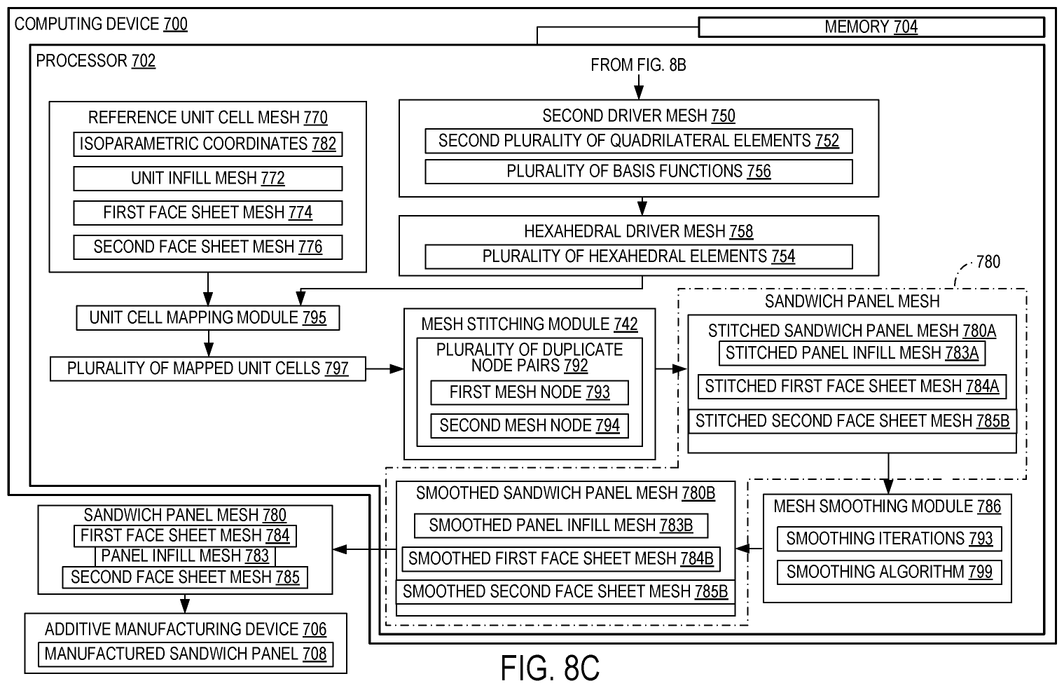

FIGS. 8A-8C schematically show a computing device 700 at which a panel infill mesh and face sheet meshes of a sandwich panel are generated, according to the example of FIGS. 1A-1B. As shown in FIGS. 8A-8C, the computing device 700 includes a processor 702 and memory 704. The processor 702 includes one or more processing devices, which include, for example, one or more central processing units (CPUs), one or more graphics processing units (GPUs), and/or one or more other hardware accelerators. The memory 704 is provided as one or more memory devices, which include, for example, one or more volatile memory devices and one or more non-volatile storage devices. One or more user input devices and one or more user output devices are also included in the computing device 700 in some examples. In some examples, the processor 702 and the memory 704 are included in one or more components that combine processor and memory functionality, such as a system-on-a-chip (SoC). Additionally or alternatively, in some examples, the one or more processor 702 and the memory 704 are distributed across a plurality of physical computing systems, such as a plurality of networked computing devices located in a data center.

As shown in FIG. 8A, the processor 702 is configured to receive a mid-surface CAD geometry 712 representing a panel mid-surface of a sandwich panel. The mid-surface CAD geometry 712 has a 2-manifold form. In some embodiments this geometry is received in a common CAD file format such as STEP, ACIS, Parasolids or the like. The processor 702 is further configured to generate an initial state 703 using mid-surface CAD geometry 712 for one or more physics solvers 725 to receive as input. The one or more physics solvers 725 iteratively perform corresponding physics computations based on a current state (initial state 703 or updated state 705) of the system to evaluate an objective value for each objective function, as shown at 731. A topology optimization algorithm 730 computes an updated state 705 for the system including updated values for the updated density field 734B and updated material property fields 735B in each iteration of the computation loop. When one or more convergence conditions are met, as shown at 733, a converged density field 734C is outputted. This process is described in described detail below.

The initial state 703 includes a first driver mesh 720, an initial density field 734A that contains initial values for the density field 734, and initial material property field 735A that contains initial values for a material property field. The material property field may include values for a material property that is a function of the density field and which is updated during the computation loop to an updated material property field, as shown at 735B.

The first driver mesh 720 includes a first plurality of quadrilateral elements 722 which form a design domain 718. Using the topology optimization algorithm 730, which iteratively executes physics solver 725, the processor 702 is further configured to generate the updated density field 734B defined on the design domain 718, while minimizing the one or more objective functions 732 in the computational loop until convergence conditions are met as shown at 733. Optionally, this topology optimization algorithm 730 may be subject to the one or more constraints 736. The density field 734 is computed based at least in part on the initial state 703, by iteratively computing the value of one or more objective functions 732 (one value per objective function 732) using the one or more physics solvers 725. Physics solvers 725 use design domain 718, one or more loads 714, one or more boundary conditions 716, as well as the updated values for the material property 735B in order to compute the one or more objective values for a given density field. The updated material properties 735B are, at least in part, based on the updated density field 734B.

The computation loop continues until the convergence conditions are determined to be met (YES at 733). More particularly, at each iteration of the computation loop, updated values for the density field 734B for the current iteration are computed and updated material property fields 735B for the current iteration are evaluated based on the updated density field 734B. These updated values are fed to the physics solvers 725 in the computational loop, which solve for and output the one or more objective values 731, given the loads 714 and boundary conditions 716. At 733, processor 702 is configured to determine if the convergence conditions have been met, for example, by determining that each of the one or more objective functions have converged to within a predetermined threshold convergence value, and that the optional constraints 736 (if any) have been met. If the convergence conditions are not satisfied, the computation continues through another computational loop (NO at 733) and if the convergence conditions are met (YES at 733), then the density field 734 is deemed converged, and a converged density field 734C is outputted.

As briefly discussed above, each physics solver 725 executed by the processor 702 is configured to receive one or more loads 714 applied to the sandwich panel. The one or more loads 714 can include, for example, a mechanical force 714A, a mechanical torque 714B, a heat flux 714C, and/or an electrical current 714D. In addition, the physics solver 725 executed by the processor 702 is further configured to receive one or more boundary conditions 716 of the sandwich panel. The one or more boundary conditions 716 include, for example, an enforced translational displacement condition 716A, an enforced rotational displacement condition 716B, an enforced temperature 716C, and/or an enforced electric field 716D. The one or more physics solvers 725 are configured to iteratively solve for objective values 731 of the one or more objective functions 732 at each iteration of the computation loop, given the loads 714 and boundary conditions 716, until the convergence conditions are detected to have been met at 733.

The topology optimization algorithm 730 can be, for example, a Solid Isotropic Material with Penalization (SIMP) algorithm, a Rational Approximation of Material Properties (RAMP) algorithm, an Evolutionary Structural Optimization (ESO) algorithm, a Bi-Directional Evolutionary Structural Optimization (BESO) algorithm, a Level Set Topology Optimization (LSTO) algorithm, or a Phase Field Topology Optimization (PFTO) algorithm. When the topology optimization algorithm 730 is executed, the processor 702 is configured to iteratively execute a physics solver 725 which performs a numerical algorithm, which is, for example, a Galerkin method (e.g., the finite element method or isogeometric analysis), a finite volume method, a discontinuous Galerkin method, a stochastic method (e.g., random walk or walk on spheres), a finite difference method, or a spectral method, that is used to compute the one or more objective values 731 for the one or more objective functions 732.

The one or more objective functions 732 can include a stiffness objective function 732A in some examples. In such examples, the stiffness objective function 732A can indicate an objective to minimize an integral of an elastic strain energy W over the mid-surface CAD geometry 712. The elastic strain energy W is a scalar value that can be computed by contracting a linear strain tensor ε with a material constitutive tensor C and then contracting the result with the linear strain tensor ε again. Thus, the elastic strain energy W is computed as follows:

$$W = ε : C : ε$$

or, in index notation:

$$W = {ε}_{ij} {C}_{ijkl} {ε}_{kl}$$

In some examples, the one or more objective functions 732 additionally or alternatively can include a thermal conduction objective function 732B. In such examples, the thermal conduction objective function 732B can indicate an objective to minimize an integral of a thermal energy E over the mid-surface CAD geometry 712. The thermal energy E is computed as the divergence of the gradient of a temperature field T times a thermal conductivity K of the material of the sandwich panel. Thus, the thermal energy E is computed as follows:

$$E = ∇ \cdot ( κ ∇ T )$$

In some examples, the one or more objective functions 732 additionally or alternatively can include an electrical conduction objective function 732C. In such examples, the electrical conduction objective function 732C can indicate an objective to minimize an integral of an electrical energy E over the mid-surface CAD geometry 712. The electrical energy E is computed as the divergence of the gradient of an electrostatic potential field ϕ times an electrical permittivity ∈ of the material of the sandwich panel. Thus, the electrical energy E is computed as follows:

$$E = ∇ \cdot ( ϵ ∇ ϕ )$$

The topology optimization algorithm 730 is subjected to one or more constraints 736 in some examples. It will be appreciated that constraints 736 are optional and may not be included in other implementations. For example, the one or more constraints 736 can include a mass constraint 736A, a volume constraint 736B, an overhang constraint 736C, a minimum wall thickness constraint 736D, and a closed cell structure constraint 736E. In such examples, the mass constraint 736A is a target mass of the sandwich panel. The volume constraint 736B is a target volume of the sandwich panel. The overhang constraint 736C is a maximum horizontal distance by which a portion of the density field 734 is allowed to extend without a support located below that portion or a maximum build angle (e.g. a maximum unsupported wall angle that is permissible in the structure). The minimum wall thickness constraint 736D is a minimum thickness of the walls of cell structures included in the density field 734. The closed cell structure constraint 736E is a constraint specifying that the density field 734 does not contain any fully enclosed void regions. The last of these constraints may, for example, be useful in additive manufacturing processes that rely on fusing powder feedstock as it is often a requirement to be able to remove excess unfused powder once a part is printed.

Turning now to FIG. 8B, the processor 702 is further configured to compute an element size field 740. The element size field 740 is computed using a density mapping function 746 that maps each of a plurality of the density values included in the density field 734 to a corresponding element size. In one example implementation, the density values are mapped to either a first target element size (e.g., minimum target element size 744) or a second target element size (e.g., maximum target element size 745). In another example, the density values are mapped to multiple element sizes between the minimum target element size 744 and the maximum target element size 745, inclusive. The density values used as inputs to the density mapping function 746 are, in some examples, within the range [0,1]. In some examples, all the density values included in the density field 734 are mapped to respective target element sizes, whereas in other examples, a reduced subset of the density field 734 is used as input to the density mapping function 746, such as the density values 738 of points spaced at some predefined interval.

The processor 702 is configured to execute a mesh generation module 777, which is configured to receive as inputs the element size field 740 and the mid-surface CAD geometry 712, and compute a second driver mesh 750 based at least in part on the density field 734 and mid surface CAD geometry 712. The second driver mesh 750 includes a second plurality of quadrilateral elements 752 that have respective element sizes specified by the element size field 740. In some embodiments, when the second driver mesh 750 is generated, the processor 702 is configured to specify the respective element sizes of the second plurality of quadrilateral elements 752 as either a minimum target element size 744 or a maximum target element size 745 as indicated in the element size field 740.

During generation of the second driver mesh 750, the mesh generation module 777 executed by processor 702 is configured to compute a point set 760 based at least in part on the element size field 740 and the mid surface CAD geometry 712. The point set 760 includes a plurality of points 762 distributed over the mid-surface CAD geometry 712 such that the element size field 740 specifies distances between neighboring pairs of points 762 included in the point set 760.

The mesh generation module 777 can be configured to compute the second plurality of quadrilateral elements 752 of the second driver mesh 750 directly from the plurality of points 762. Alternatively, the mesh generation module can be configured to compute the second plurality of quadrilateral elements 752 of the second driver mesh 750 from plurality of points 762 in the point set 760 using Delaunay triangulation. When using Delaunay triangulation, the processor 702 is further configured to compute a plurality of triangular elements 766 from the point set 760. The processor 702 is further configured to combine the triangular elements 766 into the second plurality of quadrilateral elements 752 to obtain the second driver mesh 750. Each of the second plurality of quadrilateral elements 752 is formed by combining a pair of adjacent triangular elements 766. Thus, the processor 702 is configured to compute the second driver mesh 750 such that the sizes of the second plurality of quadrilateral elements 752 approximately match the values given by the density mapping function 746 at all locations on mid-surface CAD geometry 712.

FIG. 8C schematically shows the computing device 700 when the processor 702 further is configured to compute a sandwich panel mesh 780 using the second driver mesh 750. As an input to the computation of the sandwich panel mesh 780, the processor 702 is configured to receive a reference unit cell mesh 770 configured to fit within a cube. The reference unit cell mesh 770 specifies a three-dimensional geometric structure of the unit cells that form the repeating unit structure of the sandwich panel mesh 780 described below. The reference unit cell mesh 770 includes isoparametric coordinates 782, a unit infill mesh 772, and a pair of unit face sheet meshes including a first face sheet mesh 774 and a second face sheet mesh 776, located at opposite ends of the unit infill mesh 772.

The second driver mesh 750 is used to compute sandwich panel mesh 780, including panel infill mesh 783 and face sheet meshes 784 and 785. The sandwich panel mesh 780 has a panel infill geometry interconnecting a pair of face sheet meshes, namely, first face sheet mesh 784 and second face sheet mesh 785. The computation of the sandwich panel mesh 780 will now be described in more detail.

To compute the sandwich panel mesh 780, the processor 702 is further configured to generate a hexahedral driver mesh 758 from the second driver mesh 750 by extruding the elements in a direction normal to the midplane surface for a distance equal to half the panel thickness in either direction (i.e. above and below the element). Processor 702 is then configured to map a plurality of copies of the reference unit cell mesh 770 onto a respective plurality of hexahedral elements 754 associated with the second plurality of quadrilateral elements 752.

More particularly, the processor 702 is configured to execute a unit cell mapping module 795 to map the copies of the reference unit cell mesh 770 onto each element in the plurality of hexahedral elements 754 using a plurality of basis functions 756 of the second driver mesh 750. The basis functions 756 are defined on each of the second plurality of quadrilateral elements 752 and are configured to conform the copies of the reference unit cell mesh 770 to the hexahedral elements 754 by adjusting the respective sizes and shapes of the copies of the reference unit cell mesh 770. Thus, the mapped copies include a plurality of mapped unit cells 797. Accordingly, the processor 702 is configured to generate the mapped copies of the reference unit cell mesh 770 that are included in the sandwich panel mesh 780.

Subsequently to computing the mapped copies of the plurality of unit cells 797, the processor 702 is further configured to execute a mesh stitching module 742 to stitch together the mapped copies (mapped unit cells 797) of the reference unit cell mesh 770. The mesh stitching module 742 performs this stitching by identifying a plurality of duplicate node pairs 792 of cell mesh nodes included in the sandwich panel mesh 780, including a first mesh node 793 and a second mesh node 794. Cell mesh nodes are part of a duplicate node pair 792 if those cell mesh nodes have the same X, Y and Z coordinates (within a threshold). Thus, first mesh node 793 and second mesh node 794 have been determined to have the same position. The processor 702 is further configured to update the sandwich panel mesh 780 by deleting a respective cell mesh node from each of the one or more identified duplicate node pairs 792, so that duplicates are removed and only one cell mesh node remains at the location. The mesh stitching module 742 is configured to output a stitched sandwich panel mesh 780A, including a stitched infill mesh 783A, with a stitched first face sheet mesh 784A and a stitched second face sheet mesh 785B as a result of this process.

In some examples, the processor 702 is further configured to execute a mesh smoothing module 786 configured to smooth the sandwich panel mesh 780, for example, in a direction locally orthogonal to the normal of mid-surface CAD geometry 712. In such examples, the processor 702 is configured to compute a smoothed sandwich panel mesh 780B that includes a plurality of mapped copies 796 of the reference unit cell mesh 770 which have subsequently been smoothed. In some such examples, the sandwich panel mesh 780 is smoothed over a plurality of smoothing iterations 793 using a smoothing algorithm 799, to generate a smoothed sandwich panel mesh 780B including a smoothed panel infill mesh 783B, smoothed first face sheet mesh 784B, and smoothed second face sheet mesh 785B.

The processor 702 is further configured to output the sandwich panel mesh 780 to an additive manufacturing device 706. When smoothing is used, the outputted sandwich panel mesh 780 is in the form of the smoothed sandwich panel mesh 780B. The additive manufacturing device 706 is further configured to additively manufacture a sandwich panel 708 according to the sandwich panel mesh 780. The particular type of additive manufacturing device is not limited, but examples included devices configured to perform vat photopolymerization, material jetting, binder jetting, material extrusion, powder bed fusion, sheet lamination, and directed energy deposition.

It will be appreciated that the additively manufactured sandwich panel 708 manufactured using the systems and methods described herein may have complex and varying geometries not achievable by traditional manufacturing methods. Traditional sandwich panels use standard infill that are often in the shape of a honeycomb pattern with constant density. Using the approaches described herein, unit cells in a limitless variety of shapes, including honeycomb, can be used and this is not possible with conventional manufacturing techniques. Examples of sandwich panel infill which cannot be achieved using traditional manufacturing techniques include Gyroid, Schwarz-P and Schwarz-D unit cells. Further, the ability to vary the density of the infill in sandwich panels manufactured according to the techniques described herein, wherein the unit cells are conformal to the sandwich panel mid-surface, provides great flexibility in achieving panels that exhibit a desired design characteristic with a varying infill pattern, to thereby realize efficient use of additive material. The resultant complex and varying infill geometries may exhibit advantageous mechanical, electrical, and thermal properties to a desired degree in differing areas of the part. As one example, since it will be appreciated that traditional manufacturing techniques permit only constant density infills, sandwich panels manufactured with the above described systems and methods can have a lower mass than a panel formed of a constant density infill, while still exhibiting the desired mechanical, electrical and/or thermal properties described above, such as desired stiffness, etc., as needed in a varying manner across the part geometry.

In some embodiments, the methods and processes described herein may be tied to a computing system of one or more computing devices. In particular, such methods and processes may be implemented as a computer-application program or service, an application-programming interface (API), a library, and/or other computer-program product.

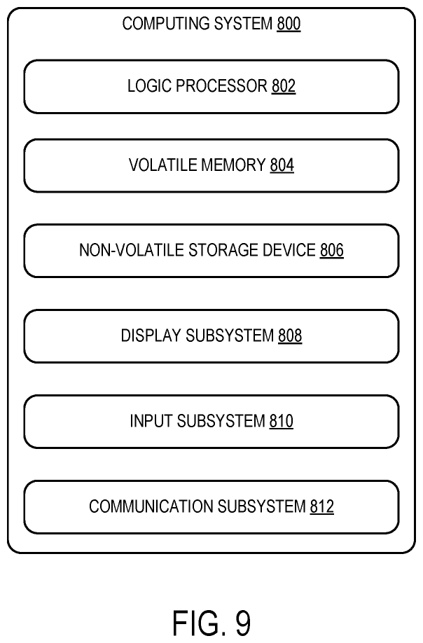

FIG. 9 schematically shows a non-limiting embodiment of a computing system 800 that can enact one or more of the methods and processes described above. Computing system 800 is shown in simplified form. Computing system 800 may embody the computing device 700 described above and illustrated in FIGS. 8A-8C. Components of computing system 800 may be included in one or more personal computers, server computers, tablet computers, home-entertainment computers, network computing devices, video game devices, mobile computing devices, mobile communication devices (e.g., smart phone), and/or other computing devices, and wearable computing devices such as smart wristwatches and head mounted augmented reality devices.

Computing system 800 includes a logic processor 802 volatile memory 804, and a non-volatile storage device 806. Computing system 800 may optionally include a display subsystem 808, input subsystem 810, communication subsystem 812, and/or other components not shown in FIG. 9.

Logic processor 802 includes one or more physical devices configured to execute instructions. For example, the logic processor may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor 802 may include one or more physical processors configured to execute software instructions. Additionally or alternatively, the logic processor may include one or more hardware logic circuits or firmware devices configured to execute hardware-implemented logic or firmware instructions. Processors of the logic processor 802 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor may be virtualized and executed by remotely accessible, networked computing devices configured in a cloud-computing configuration. In such a case, these virtualized aspects are run on different physical logic processors of various different machines, it will be understood.

Non-volatile storage device 806 includes one or more physical devices configured to hold instructions executable by the logic processors to implement the methods and processes described herein. When such methods and processes are implemented, the state of non-volatile storage device 806 may be transformed—e.g., to hold different data.

Non-volatile storage device 806 may include physical devices that are removable and/or built in. Non-volatile storage device 806 may include optical memory, semiconductor memory, and/or magnetic memory, or other mass storage device technology. Non-volatile storage device 806 may include nonvolatile, dynamic, static, read/write, read-only, sequential-access, location-addressable, file-addressable, and/or content-addressable devices. It will be appreciated that non-volatile storage device 806 is configured to hold instructions even when power is cut to the non-volatile storage device 806.

Volatile memory 804 may include physical devices that include random access memory. Volatile memory 804 is typically utilized by logic processor 802 to temporarily store information during processing of software instructions. It will be appreciated that volatile memory 804 typically does not continue to store instructions when power is cut to the volatile memory 804.

Aspects of logic processor 802, volatile memory 804, and non-volatile storage device 806 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 800 typically implemented in software by a processor to perform a particular function using portions of volatile memory, which function involves transformative processing that specially configures the processor to perform the function. Thus, a module, program, or engine may be instantiated via logic processor 802 executing instructions held by non-volatile storage device 806, using portions of volatile memory 804. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 808 may be used to present a visual representation of data held by non-volatile storage device 806. The visual representation may take the form of a graphical user interface (GUI). As the herein described methods and processes change the data held by the non-volatile storage device, and thus transform the state of the non-volatile storage device, the state of display subsystem 808 may likewise be transformed to visually represent changes in the underlying data. Display subsystem 808 may include one or more display devices utilizing virtually any type of technology. Such display devices may be combined with logic processor 802, volatile memory 804, and/or non-volatile storage device 806 in a shared enclosure, or such display devices may be peripheral display devices.

When included, input subsystem 810 may comprise or interface with one or more user-input devices such as a keyboard, mouse, touch screen, camera, or microphone.

When included, communication subsystem 812 may be configured to communicatively couple various computing devices described herein with each other, and with other devices. Communication subsystem 812 may include wired and/or wireless communication devices compatible with one or more different communication protocols. As non-limiting examples, the communication subsystem may be configured for communication via a wired or wireless local- or wide-area network, broadband cellular network, etc. In some embodiments, the communication subsystem may allow computing system 800 to send and/or receive messages to and/or from other devices via a network such as the Internet.

Further, the disclosure comprises configurations according to the following clauses.

Clause 1. A method of generating a sandwich panel geometry of a sandwich panel, comprising: providing a mid-surface computer-aided design (CAD) geometry representing a panel mid-surface of a sandwich panel, wherein the mid-surface CAD geometry has a 2-manifold form; generating a first driver mesh of the mid-surface CAD geometry, wherein the first driver mesh includes a first plurality of quadrilateral elements; using a topology optimization algorithm that has one or more objective functions, generating a density field defined on the first driver mesh; computing a second driver mesh of the mid-surface CAD geometry based at least in part on the density field, wherein: the second driver mesh includes a second plurality of quadrilateral elements; and the second plurality of quadrilateral elements have respective element sizes specified by an element size field that is computed based at least in part on the density field; providing a reference unit cell mesh that has a unit cell geometry configured to fit within a cube, wherein the reference unit cell mesh includes a unit infill mesh and a pair of unit face sheet meshes at opposite ends of the unit infill mesh; mapping a plurality of copies of the reference unit cell mesh onto a respective plurality of hexahedral elements associated with the second plurality of quadrilateral elements, wherein the mapped copies of the reference unit cell mesh form a sandwich panel mesh that has a panel infill mesh interconnecting a pair of face sheet meshes; and outputting a sandwich panel mesh including the panel infill mesh and the face sheet meshes.

Clause 2. The method of Clause 1, wherein: the sandwich panel mesh is output to an additive manufacturing device; and the method further comprises additively manufacturing the sandwich panel at the additive manufacturing device according to the sandwich panel mesh.

Clause 3. The method of Clause 1 or 2, wherein the copies of the reference unit cell mesh are mapped onto the hexahedral elements using a plurality of basis functions that are defined on each of the second plurality of quadrilateral elements and that are configured to conform the copies of the reference unit cell mesh to the hexahedral elements by adjusting the respective sizes and shapes of the copies of the reference unit cell mesh.

Clause 4. The method of any of Clauses 1-3, wherein executing the topology optimization algorithm includes solving one or more physics boundary value problems by performing one or more numerical methods over a plurality of topology optimization iterations.

Clause 5. The method of Clause 4, wherein the topology optimization algorithm is a Solid Isotropic Material with Penalization (SIMP) algorithm, a Rational Approximation of Material Properties (RAMP) algorithm, an Evolutionary Structural Optimization (ESO) algorithm, a Bi-Directional Evolutionary Structural Optimization (BESO) algorithm, a Level Set Topology Optimization (LSTO) algorithm, or a Phase Field Topology Optimization (PFTO) algorithm.

Clause 6. The method of any of Clauses 1-5, further comprising computing the element size field using a density mapping function that maps each of a plurality of density values included in the density field to either a first target element size or a second target element size.

Clause 7. The method of any of Clauses 1-6, further comprising computing a point set based at least in part on the element size field, wherein: the point set includes a plurality of points distributed over the mid-surface CAD geometry; the element size field specifies distances between neighboring points included in the point set; and computing the second driver mesh includes: computing a plurality of triangular cells from the point set via Delaunay triangulation; and combining the triangular cells into the second plurality of quadrilateral elements.

Clause 8. The method of Clauses 1-7, further comprising smoothing the sandwich panel mesh in a direction locally orthogonal to a normal of the mid-surface CAD geometry.

Clause 9. The method of Clause 8, wherein the sandwich panel mesh is smoothed over a plurality of smoothing iterations.

Clause 10. The method of any of Clauses 1-9, further comprising: receiving one or more loads applied to the sandwich panel and one or more boundary conditions of the sandwich panel; and computing the density field based at least in part on the one or more loads and the one or more boundary conditions.

Clause 11. The method of Clause 10, wherein the one or more loads include a mechanical force, a mechanical torque, a heat flux, and/or an electrical current.

Clause 12. The method of Clause 10 or 11, wherein the one or more boundary conditions include an enforced translational displacement boundary condition, an enforced rotational displacement boundary condition, an enforced temperature boundary condition, and/or an enforced electric field boundary condition.

Clause 13. The method of any of Clauses 1-12, wherein the one or more objective functions include an elastic strain energy objective function, a thermal energy objective function, an electrical energy objective function, and/or an acoustic energy objective function.

Clause 14. The method of any of Clauses 1-13, wherein the topology optimization algorithm is subjected to one or more constraints that are each selected from the group consisting of a mass constraint, a volume constraint, an overhang constraint, a minimum wall thickness constraint, and a closed cell structure constraint.

Clause 15. The method of any of Clauses 1-14, further comprising stitching together the mapped copies of the reference unit cell mesh at least in part by: identifying one or more pairs of cell mesh nodes included in the sandwich panel mesh that are duplicate nodes; and updating the sandwich panel mesh by deleting a respective cell mesh node from each of the one or more identified pairs.

Clause 16. A sandwich panel comprising: a first face sheet; a second face sheet; and a panel infill structure, wherein: the panel infill structure includes a plurality of unit cell structures that connect the first face sheet to the second face sheet; each of the unit cell structures has a main axis that is locally normal to a panel mid-surface of the sandwich panel; and the panel infill structure is generated at least in part by: mapping a plurality of hexahedral elements to respective quadrilaterals included in a driver mesh to thereby obtain a sandwich panel mesh, wherein: the plurality of hexahedral elements specify respective sizes and shapes of the unit cell structures; and the driver mesh is generated based at least in part on a density field computed using a topology optimization algorithm; and as specified by the sandwich panel mesh, additively manufacturing the sandwich panel, including the first face sheet, the second face sheet, and the panel infill structure.

Clause 17. The sandwich panel of Clause 16, wherein the topology optimization algorithm is a Solid Isotropic Material with Penalization (SIMP) algorithm, a Rational Approximation of Material Properties (RAMP) algorithm, an Evolutionary Structural Optimization (ESO) algorithm, a Bi-Directional Evolutionary Structural Optimization (BESO) algorithm, a Level Set Topology Optimization (LSTO) algorithm, or a Phase Field Topology Optimization (PFTO) algorithm.

Clause 18. The sandwich panel of Clause 16 or 17, wherein generating the panel infill structure further includes smoothing the sandwich panel mesh in a direction locally orthogonal to a normal of the mid-surface CAD geometry.

Clause 19. The sandwich panel of any of Clauses 16-18, wherein generating the sandwich panel mesh further includes: receiving one or more loads applied to the sandwich panel and one or more boundary conditions applied to the sandwich panel; and computing the density field based at least in part on the one or more loads and the one or more boundary conditions.

Clause 20. A computing device comprising: a processor configured to: receive a mid-surface computer-aided design (CAD) geometry representing a panel mid-surface of a sandwich panel, wherein the mid-surface CAD geometry has a 2-manifold form; generate a first driver mesh of the mid-surface CAD geometry, wherein the first driver mesh includes a first plurality of quadrilateral elements; using a topology optimization algorithm that has one or more objective functions, generate a density field defined on the first driver mesh; compute a second driver mesh of the mid-surface CAD geometry based at least in part on the density field, wherein: the second driver mesh includes a second plurality of quadrilateral elements; and the second plurality of quadrilateral elements have respective element sizes specified by an element size field that is computed based at least in part on the density field; receive a reference unit cell mesh that has a unit cell geometry configured to fit within a cube, wherein the reference unit cell mesh includes a unit infill mesh and a pair of unit face sheet meshes at opposite ends of the unit infill mesh; map a plurality of copies of the reference unit cell mesh onto a respective plurality of hexahedral elements associated with the second plurality of quadrilateral elements, wherein the mapped copies of the reference unit cell mesh form a sandwich panel mesh that has a panel infill mesh interconnecting a pair of face sheet meshes; and output the sandwich panel mesh.

“And/or” as used herein is defined as the inclusive or V, as specified by the following truth table:

| A | B | A ∨ B |
|---|---|---|
| True | True | True |
| True | False | True |
| False | True | True |
| False | False | False |

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A method of generating a sandwich panel geometry of a sandwich panel, comprising:
providing a mid-surface computer-aided design (CAD) geometry representing a panel mid-surface of a sandwich panel, wherein the mid-surface CAD geometry has a 2-manifold form;
generating a first driver mesh of the mid-surface CAD geometry, wherein the first driver mesh includes a first plurality of quadrilateral elements;
using a topology optimization algorithm that has one or more objective functions, generating a density field defined on the first driver mesh;
computing a second driver mesh of the mid-surface CAD geometry based at least in part on the density field, wherein:
the second driver mesh includes a second plurality of quadrilateral elements; and
the second plurality of quadrilateral elements have respective element sizes specified by an element size field that is computed based at least in part on the density field;
providing a reference unit cell mesh that has a unit cell geometry configured to fit within a cube, wherein the reference unit cell mesh includes a unit infill mesh and a pair of unit face sheet meshes at opposite ends of the unit infill mesh;
mapping a plurality of copies of the reference unit cell mesh onto a respective plurality of hexahedral elements associated with the second plurality of quadrilateral elements, wherein the mapped copies of the reference unit cell mesh form a sandwich panel mesh that has a panel infill mesh interconnecting a pair of face sheet meshes; and
outputting a sandwich panel mesh including the panel infill mesh and the face sheet meshes.

2. The method of claim 1, wherein:
the sandwich panel mesh is output to an additive manufacturing device; and
the method further comprises additively manufacturing the sandwich panel at the additive manufacturing device according to the sandwich panel mesh.

3. The method of claim 1, wherein the copies of the reference unit cell mesh are mapped onto the hexahedral elements using a plurality of basis functions that are defined on each of the second plurality of quadrilateral elements and that are configured to conform the copies of the reference unit cell mesh to the hexahedral elements by adjusting the respective sizes and shapes of the copies of the reference unit cell mesh.

4. The method of claim 1, wherein executing the topology optimization algorithm includes solving one or more physics boundary value problems by performing one or more numerical methods over a plurality of topology optimization iterations.

5. The method of claim 4, wherein the topology optimization algorithm is a Solid Isotropic Material with Penalization (SIMP) algorithm, a Rational Approximation of Material Properties (RAMP) algorithm, an Evolutionary Structural Optimization (ESO) algorithm, a Bi-Directional Evolutionary Structural Optimization (BESO) algorithm, a Level Set Topology Optimization (LSTO) algorithm, or a Phase Field Topology Optimization (PFTO) algorithm.

6. The method of claim 1, further comprising computing the element size field using a density mapping function that maps each of a plurality of density values included in the density field to either a first target element size or a second target element size.

7. The method of claim 1, further comprising computing a point set based at least in part on the element size field, wherein:
the point set includes a plurality of points distributed over the mid-surface CAD geometry;
the element size field specifies distances between neighboring points included in the point set; and
computing the second driver mesh includes:
computing a plurality of triangular cells from the point set via Delaunay triangulation; and
combining the triangular cells into the second plurality of quadrilateral elements.

8. The method of claim 1, further comprising smoothing the sandwich panel mesh in a direction locally orthogonal to a normal of the mid-surface CAD geometry.

9. The method of claim 8, wherein the sandwich panel mesh is smoothed over a plurality of smoothing iterations.

10. The method of claim 1, further comprising:
receiving one or more loads applied to the sandwich panel and one or more boundary conditions of the sandwich panel; and
computing the density field based at least in part on the one or more loads and the one or more boundary conditions.

11. The method of claim 10, wherein the one or more loads include a mechanical force, a mechanical torque, a heat flux, and/or an electrical current.

12. The method of claim 10, wherein the one or more boundary conditions include an enforced translational displacement boundary condition, an enforced rotational displacement boundary condition, an enforced temperature boundary condition, and/or an enforced electric field boundary condition.

13. The method of claim 1, wherein the one or more objective functions include an elastic strain energy objective function, a thermal energy objective function, an electrical energy objective function, and/or an acoustic energy objective function.

14. The method of claim 1, wherein the topology optimization algorithm is subjected to one or more constraints that are each selected from the group consisting of a mass constraint, a volume constraint, an overhang constraint, a minimum wall thickness constraint, and a closed cell structure constraint.

15. The method of claim 1, further comprising stitching together the mapped copies of the reference unit cell mesh at least in part by:
identifying one or more pairs of cell mesh nodes included in the sandwich panel mesh that are duplicate nodes; and
updating the sandwich panel mesh by deleting a respective cell mesh node from each of the one or more identified pairs.

16. A sandwich panel comprising:
a first face sheet;
a second face sheet; and
a panel infill structure, wherein:
the panel infill structure includes a plurality of unit cell structures that connect the first face sheet to the second face sheet;
each of the unit cell structures has a main axis that is locally normal to a panel mid-surface of the sandwich panel; and
the panel infill structure is generated at least in part by:
mapping a plurality of hexahedral elements to respective quadrilaterals included in a driver mesh to thereby obtain a sandwich panel mesh, wherein:
the plurality of hexahedral elements specify respective sizes and shapes of the unit cell structures; and
the driver mesh is generated based at least in part on a density field computed using a topology optimization algorithm; and
as specified by the sandwich panel mesh, additively manufacturing the sandwich panel, including the first face sheet, the second face sheet, and the panel infill structure.

17. The sandwich panel of claim 16, wherein the topology optimization algorithm is a Solid Isotropic Material with Penalization (SIMP) algorithm, a Rational Approximation of Material Properties (RAMP) algorithm, an Evolutionary Structural Optimization (ESO) algorithm, a Bi-Directional Evolutionary Structural Optimization (BESO) algorithm, a Level Set Topology Optimization (LSTO) algorithm, or a Phase Field Topology Optimization (PFTO) algorithm.

18. The sandwich panel of claim 16, wherein generating the panel infill structure further includes smoothing the sandwich panel mesh in a direction locally orthogonal to a normal of the mid-surface CAD geometry.

19. The sandwich panel of claim 16, wherein generating the sandwich panel mesh further includes:
receiving one or more loads applied to the sandwich panel and one or more boundary conditions applied to the sandwich panel; and
computing the density field based at least in part on the one or more loads and the one or more boundary conditions.

20. A computing device comprising:
a processor configured to:
receive a mid-surface computer-aided design (CAD) geometry representing a panel mid-surface of a sandwich panel, wherein the mid-surface CAD geometry has a 2-manifold form;
generate a first driver mesh of the mid-surface CAD geometry, wherein the first driver mesh includes a first plurality of quadrilateral elements;
using a topology optimization algorithm that has one or more objective functions, generate a density field defined on the first driver mesh;
compute a second driver mesh of the mid-surface CAD geometry based at least in part on the density field, wherein:
the second driver mesh includes a second plurality of quadrilateral elements; and
the second plurality of quadrilateral elements have respective element sizes specified by an element size field that is computed based at least in part on the density field;
receive a reference unit cell mesh that has a unit cell geometry configured to fit within a cube, wherein the reference unit cell mesh includes a unit infill mesh and a pair of unit face sheet meshes at opposite ends of the unit infill mesh;
map a plurality of copies of the reference unit cell mesh onto a respective plurality of hexahedral elements associated with the second plurality of quadrilateral elements, wherein the mapped copies of the reference unit cell mesh form a sandwich panel mesh that has a panel infill geometry interconnecting a pair of face sheet meshes; and
output the sandwich panel mesh.
